(19) United States
(12) Patent Application Publication
(10) Pub. No.: US 2026/0178271 A1
(43) Pub. Date: Jun. 25, 2026

(54) METHOD FOR UTILIZING VOICE ASSISTANT BASED ON CONVERSATION CONTEXT AND ELECTRONIC DEVICE THEREFOR

(71) Applicant: Samsung Electronics Co., Ltd., Suwon-si (KR)

(72) Inventors: Eunkyung LEE, Suwon-si (KR); Dayoung CHUNG, Suwon-si (KR); Dohee CHUNG, Suwon-si (KR); Kyoungtaek KIM, Suwon-si (KR); Semin PARK, Suwon-si (KR); Jinwoo PARK, Suwon-si (KR); Hyungjin PARK, Suwon-si (KR); Seoyoung SON, Suwon-si (KR)

(21) Appl. No.: 19/542,137

(22) Filed: Feb. 17, 2026

Related U.S. Application Data
(63) Continuation of application No. PCT/KR2024/013335, filed on Sep. 4, 2024.

(30) Foreign Application Priority Data
Sep. 15, 2023 (KR) 10-2023-0123287
Mar. 19, 2024 (KR) 10-2024-0037790

(51) Int. Cl. G06F 3/16; G06F 16/3349

(52) U.S. Cl. CPC G06F 3/167; G06F 16/3349

(57) ABSTRACT

An electronic device is provided. The electronic device includes a display, memory, including one or more storage media, storing instructions, and at least one processor communicatively coupled to the display and the memory, wherein the instructions, when executed by the at least one processor individually or collectively, cause the electronic device to receive a user query through a voice assistant, identify previous conversation information having a conversation topic associated with the user query, if there is the identified previous conversation information, display a previous conversation call object on the display, determine whether a user input for selecting the previous conversation call object is detected, and if the user input is detected, provide a response based on the identified previous conversation information and the user query.

### CROSS-REFERENCE TO RELATED APPLICATION(S)

This application is a continuation application, claiming priority under 35 U.S.C. § 365 (c), of an International application No. PCT/KR2024/013335, filed on Sep. 4, 2024, which is based on and claims the benefit of a Korean patent application number 10-2023-0123287, filed on Sep. 15, 2023, in the Korean Intellectual Property Office, and of a Korean patent application number 10-2024-0037790, filed on Mar. 19, 2024, in the Korean Intellectual Property Office, the disclosure of each of which is incorporated by reference herein in its entirety.

### BACKGROUND

### 1. Field

The disclosure relates to a method of utilizing a voice assistant based on a conversation context and an electronic device thereof.

### 2. Description of Related Art

With the development of digital technologies, various types of electronic devices are being widely utilized, such as mobile communication terminals, personal digital assistants (PDA), electronic organizers, smartphones, tablet personal computers (PC), wearable devices, and the like. Hardware parts and/or software parts of such an electronic device have been continuously improved in order to support and expand the functions of the electronic device.

Recently, large language models (LLMs) have been making progress in technologies for understanding languages, as well as summarizing long sentences and compressing their content. The electronic device acquires result data (e.g., response to query) with regard to a user query via an LLM server, and provides the acquired result data to a user. However, since the result data may include a large amount of information, the user may need to search for desired information from the result data.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for providing a response suit for a user intention and conversation context when receiving a user query via a voice assistant application, by determining whether the user query is associated with a previous conversation topic, and when the user query is associated with the previous conversation topic, transmitting the user query and conversation information associated with the previous conversation topic to a server (e.g., LLM server).

Additional aspects will be set forth in part in the description which follows and, in part, will be apparent from the description, or may be learned by practice of the presented embodiments.

In accordance with an aspect of the disclosure, an electronic device is provided. The electronic device includes a display, memory, including one or more storage media, storing instructions, and at least one processor communicatively coupled to the display and the memory, wherein the instructions, when executed by the at least one processor individually or collectively, cause the electronic device to receive a user query via a voice assistant, to identify previous conversation information having a conversation topic associated with the user query, to display a previous conversation retrieval object on the display when the identified previous conversation information exists, to identify whether a user input selecting the previous conversation retrieval object is detected, and to provide a response, based on the identified previous conversation information and the user query when the user input is detected.

In accordance with another aspect of the disclosure, a method of operating an electronic device is provided. The method includes receiving a user query via a voice assistant, identifying previous conversation information having a conversation topic associated with the user query, in case that the identified previous conversation information exists, displaying a previous conversation retrieval object on a display module of the electronic device, identifying whether a user input selecting the previous conversation retrieval object is detected, and if the user input is detected, providing a response, based on the identified previous conversation information and the user query.

According to an embodiment of the disclosure, whether a user query is associated with a previous conversation topic is determined, and when the user query is associated with the previous conversation topic, the user query and conversation information associated with the previous conversation topic are transmitted to a server (e.g., an LLM server), and thus a response suit for a user intention and conversation context are provided.

According to an embodiment of the disclosure, when the conversation topic is the same, a previous user query and a response to the previous user query, in addition to a current user query, are analyzed together, and thus a more accurate response is obtained.

According to an embodiment of the disclosure, in the case in which previous conversation information exists when a voice assistant is called, the previous conversation information is displayed, thereby helping a user recognize conversation context.

According to an embodiment of the disclosure, conversation information is summarized and stored based on a conversation topic, thereby helping a user recognize previous conversation context.

According to an embodiment of the disclosure, when a current user query is the same as a previous user query, a response to the previous user query is provided without requesting, from a server, a response to the current user query or generating a response in the electronic device, and thus time spent in providing the response is shortened.

According to an embodiment of the disclosure, when providing conversation history information, a summary keyword with regard to conversation information is provided, thereby helping a user to easily find desired conversation information using the summary keyword.

In accordance with another aspect of the disclosure, one or more non-transitory computer-readable storage media storing one or more computer programs including computer-executable instruction that, when executed by one or more processors of an electronic device individually or collectively, cause the electronic device to perform operations are provided. The operations include receiving a user query via a voice assistant, identifying previous conversation information having a conversation topic associated with the user query, in case that the identified previous conversation information exists, displaying a previous conversation retrieval object on a display of the electronic device, identifying whether a user input selecting the previous conversation retrieval object is detected, and if the user input is detected, providing a response, based on the identified previous conversation information and the user query.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a generative artificial intelligence system according to an embodiment of the disclosure;

FIG. 3 is a diagram illustrating managing previous conversation information in an electronic device according to an embodiment of the disclosure;

FIG. 4 is a flowchart illustrating an operation method of an electronic device according to an embodiment of the disclosure;

FIG. 5 is a diagram illustrating calling a voice assistant in an electronic device according to an embodiment of the disclosure;

FIGS. 6A and 6B are diagrams illustrating retrieving previous conversation information in an electronic device according to various embodiments of the disclosure;

FIG. 7 is a flowchart illustrating a method of providing previous conversation information in an electronic device according to an embodiment of the disclosure;

FIG. 8A is a diagram illustrating retrieving a conversation history in an electronic device according to an embodiment of the disclosure;

FIG. 8B is a diagram illustrating providing conversation information via a conversation history summary list in an electronic device according to an embodiment of the disclosure;

FIG. 9 is a flowchart illustrating a method of providing a response based on a conversation topic associated with a user query in an electronic device according to an embodiment of the disclosure;

FIG. 10A is a diagram illustrating providing conversation history information in an electronic device according to an embodiment of the disclosure;

FIG. 10B is a diagram illustrating managing conversation history information in an electronic device according to an embodiment of the disclosure;

FIG. 11 is a diagram illustrating providing fast scrolling for a conversation history in an electronic device according to an embodiment of the disclosure;

FIGS. 12A and 12B are diagrams illustrating providing fast scrolling for a conversation history in an electronic device according to various embodiments of the disclosure;

FIGS. 13A and 13B are diagrams illustrating providing previous conversation information based on a screen size in an electronic device according to various embodiments of the disclosure;

FIG. 14 is a diagram illustrating providing a previous response depending on a user query in an electronic device according to an embodiment of the disclosure;

FIGS. 15A and 15B are diagrams illustrating providing previous conversation information differently depending on a current state of an electronic device according to various embodiments of the disclosure; and

FIGS. 16A and 16B are diagrams illustrating performing a task with regard to a user query differently depending on a current state of an electronic device according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

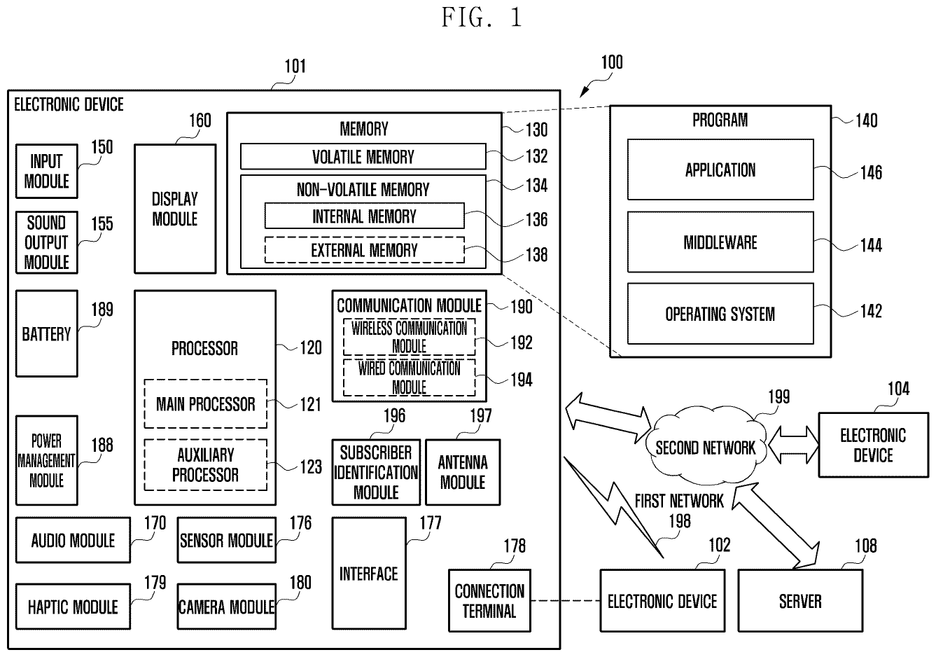

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to certain embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the PCB, or adjacent to the first surface and capable of supporting a designated high-frequency band (e.g., the mm Wave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment of the disclosure, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each element (e.g., a module or a program) of the above-described elements may include a single entity or multiple entities, and some of the multiple entities mat be separately disposed in any other element. According to various embodiments of the disclosure, one or more of the above-described elements may be omitted, or one or more other elements may be added. Alternatively or additionally, a plurality of elements (e.g., modules or programs) may be integrated into a single element. In such a case, according to various embodiments of the disclosure, the integrated element may still perform one or more functions of each of the plurality of elements in the same or similar manner as they are performed by a corresponding one of the plurality of elements before the integration. According to various embodiments of the disclosure, operations performed by the module, the program, or another element may be carried out sequentially, in parallel, repeatedly, or heuristically, or one or more of the operations may be executed in a different order or omitted, or one or more other operations may be added.

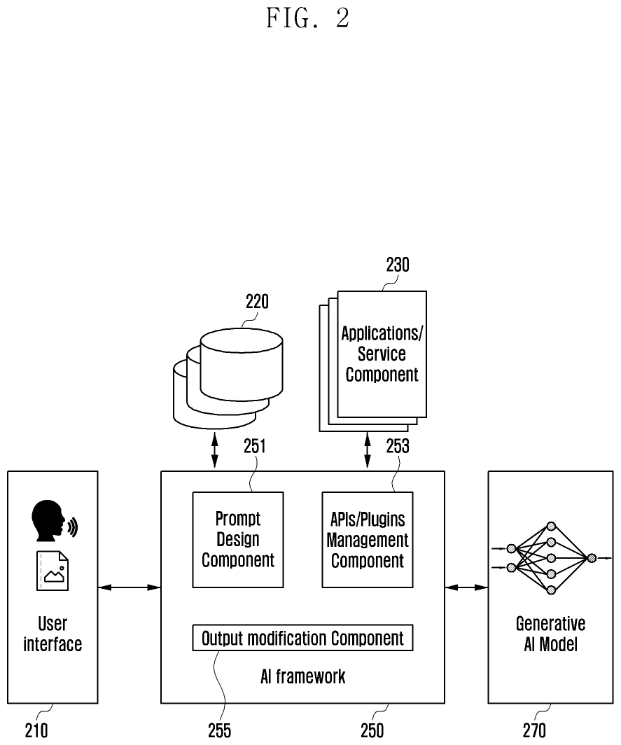

FIG. 2 is a block diagram illustrating a generative artificial intelligence system according to an embodiment of the disclosure.

Referring to FIG. 2, a generative artificial intelligence system (e.g., an intelligent server or the server 108 in FIG. 1) according to an embodiment may include a user interface 210, a database 220, application and service components 230, an AI framework 250, and a generative AI model 270.

The user interface 210 may receive an input of a user query. The user query may have the form of natural language, images, and videos. In addition, when the user makes a query, context information may be transmitted together. As another example, the user query can be an unnatural input that does not generate natural language, such as a design request or a modification. In addition, a mixed form of the above-described natural language, image, sound, and context information is also possible. Moreover, the user interface 210 may output the result of the generative artificial intelligence system to the user. The output may be in the form of natural language or a specific content, and may also be provided in the form of an action requested by the user.

The AI framework 250 may receive an input of the user query, and coordinate and control each component necessary to perform the user's intention. The AI framework 250 may include a prompt design component 251, an application and plugin (APIs/plugins) management component 253, and an output modification component 255.

The user query or action input through the user interface 210 may be transmitted to the prompt design component 251. The prompt design component 251 may be used to generate a prompt suitable for the input into a large language model (LLM) or large multimodal models. The prompt design component 251 may be an AI component that uses machine learning algorithms or neural networks to develop better prompts as time passes. The prompt design component 251 may access a knowledge component including user preference data, a prompt library, and prompt examples to generate a prompt and transfer the same to a large language model (LLM) or a large multi-modal model (LMM).

The application and plugin management component 253 may serve to perform communicating with external information if there is a request for additional information when a user input is transferred as the input of the generative model. The application and plug-in management component 253 may construct a channel capable of communicating with the outside of the AI interface through an application programming interface (API), thereby allowing access to various data sources. In addition, when an action for performing the user query rather than the intermediate result should be finally performed by an application or a service, the application and plugin management component 253 may make a request for the corresponding action through an API. The information secured from the outside may be transferred as the input of the generative model together with the user input.

The output modification component 255 may finely tune the result output from the generative model. For example, the output modification component 255 may verify whether the content generated through a language model (LLM) or a large-scale multimodal model (LMM) is irrelevant, includes biased content, or includes harmful content. In addition, the output correction component 255 may determine to which extent the output conforms to a desired result of the user, and if an additional process is needed, perform the corresponding process. Additionally, the output correction component 255 may configure a hint for avoiding an unintended output and provide the same to the user.

The generative AI model 270 generally refers to an artificial intelligence neural network that makes new types of data, depending on user input information. Typical models for generating images include a generative adversarial network (GAN) and a variational auto encoder (VAE), and recently, a diffusion-based generative model using a VAE and a Transformer structure is referred to as a generative model. In addition, the language model is a model trained to output the most appropriate output value statistically based on the input value, and examples thereof representatively include models, such as CHAT-GPT 3 and CHAT-GPT 4. Moreover, the model may recognize various types of data inputs, such as text, images, and sounds, and generate new data in response thereto, and thus is called a large multimodal model (LMM).

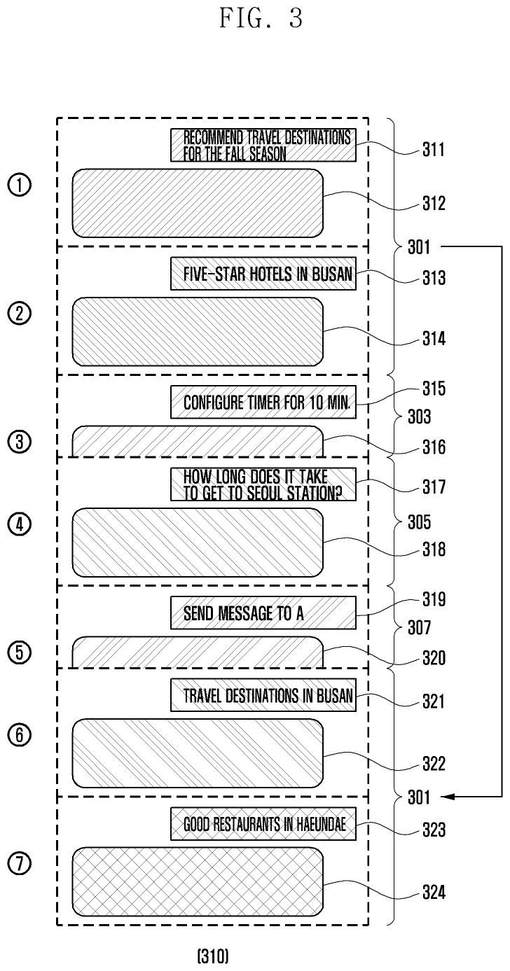

FIG. 3 is a diagram illustrating managing previous conversation information in an electronic device according to an embodiment of the disclosure.

Referring to FIG. 3, a processor (e.g., the processor 120 in FIG. 1) of an electronic device (e.g., the electronic device 101 in FIG. 1) according to an embodiment may receive a user query via a voice assistant (or voice secretary) application and provide a response (e.g., result data) with respect to the user query. The voice assistant application (or voice assistant service) may collect and provide customized information for the user based on an artificial intelligence (AI) engine and voice recognition, and perform various tasks, such as schedule management, e-mail transmission, and restaurant reservation according to the user's voice commands. For example, in order to call the voice assistant, the user may utter a predetermined voice call word (e.g., Hi Bixby) or may press a button associated with the voice assistant. The processor 120 may execute the voice assistant application when detecting a voice call word obtained via a microphone (e.g., the input module 150 in FIG. 1). Alternatively, the processor 120 may execute the voice assistant application when a button (e.g., software button or physical button) associated with the voice assistant is selected. When the button is selected, the processor 120 may display a keypad on an execution screen of the executed voice assistant application.

According to an embodiment of the disclosure, when the voice assistant is called by a button, the voice assistant may operate in a text-based manner (e.g., keypad display), or when the voice assistant is called by a voice, the voice assistant may operate in a voice-based manner (e.g., voice command reception), but is not limited thereto.

The processor 120 may receive a first user query 311 from the user via the executed voice assistant application. The first user query 311 may be a voice command obtained via a microphone or text obtained via a keypad displayed on the execution screen of the executed voice assistant application. The processor 120 may open a conversation session, receive the first user query 311, and provide a first response 312 with regard to the first user query 311. The processor 120 may assign a conversation identifier to the conversation session in which the first user query 311 is received. Alternatively, the processor 120 may assign a request identifier to the first user query 311. The processor 120 may assign the same conversation identifier to the same conversation session, and may terminate the conversation session after a specified time elapses.

For example, when a first user query starts, a conversation session may be started, and maintained for a specified time (e.g., 24 hours, 2 days, 7 days, or the like). The specified time is specified to manage a once started conversation session as the same conversation session, and may be preconfigured (stored) in the voice assistant application or configured by a user. When the conversation session is started and the user requests a forced termination of the voice assistant application, the conversation session may be terminated. The processor 120 may classify (or assign) the conversations until the first query from the forced termination or the elapse of the specified time as having the same conversation identifier. The processor 120 may assign the same conversation identifier to a user query input in a state in which the specified time is not elapsed or the voice assistant application is not terminated, as a previously input query and response. The processor 120 may assign a different conversation identifier with respect to a query/response input after the time elapses or ends.

When a previous conversation session is terminated and a new conversation session is opened, a new conversation identifier may be assigned. In addition, the request identifier is assigned per one user query, and a user query and a response to the query may be distinguished by one request identifier. The processor 120 may manage (or store in the memory (e.g., the memory 130 in FIG. 1)) a user query and a response to the user query, corresponding to one request identifier. The user query and the response to the user query may be stored in the memory 130 as conversation information.

Referring to the user interface 310, the processor 120 may store first conversation information (e.g., first user query 311 and first response 312 for the first user query) corresponding to a first request identifier 1), second conversation information (e.g., second user query 313 and second response 314 for the second user query) corresponding to a second request identifier (2), third conversation information (e.g., third user query 315 and third response 316 for the third user query) corresponding to a third request identifier (3), fourth conversation information (e.g., fourth user query 317 and fourth response 318 for the fourth user query) corresponding to a fourth request identifier 4), fifth conversation information (e.g., fifth user query 319 and fifth response 320 for the fifth user query) corresponding to a fifth request identifier (5), sixth conversation information (e.g., sixth user query 321 and sixth response 322 for the sixth user query) corresponding to a sixth request identifier 6, and seventh conversation information (e.g., seventh user query 323 and seventh response 324 for the seventh user query) corresponding to a seventh request identifier 7.

For example, the first conversation information to the seventh conversation information may be included in a first conversation session (e.g., first conversation identifier). When the voice assistant application is executed a specified time (e.g., 24 hours, 3 days, or 5 days) after the last use (or termination) of the first conversation session, a second conversation session may be generated. The specified time is specified to manage a once started conversation session as the same conversation session, and may be preconfigured (stored) in the voice assistant application or configured by a user. In addition, when the voice assistant application is executed a specified time after the last use (or termination) of the second conversation session, a third conversation session may be generated. This description is an example to help in understanding the disclosure, and is not intended to limit the scope of the disclosure.

According to an embodiment of the disclosure, the processor 120 may maintain conversation information for a specified time for one conversation session unless the specified time elapses or forced termination of the voice assistant application is requested by the user. The processor 120 may store the conversation information included in one conversation session in the memory 130. When the designated time elapses, the processor 120 may store the conversation information for which the designated time has elapsed in the memory 130 as a conversation history. The processor 120 may not store conversation information regarding a one-time user query (e.g., screen capture and today's date?) or a single-turn user query (e.g., configure a timer) when storing a conversation history.

The processor 120 may determine a conversation topic identifier (ID) upon receiving a user query. The conversation topic identifier may be used to manage conversation information corresponding to the same conversation topic. For example, although the user query or the content included in the user query is different, if the conversation topic is the same, the same conversation topic identifier may be determined (or assigned, allocated). For example, the conversation topic may be a large classification, such as a person, an object, or an animal, an intermediate classification of the object, such as a car or food, or a small classification of food, such as spaghetti or steak. The examples are provided to help in understanding the disclosure, and are not intended to limit the disclosure.

For example, the processor 120 may assign a first conversation topic identifier 301 to the first and second conversation information, assign a second conversation topic identifier 303 to the third conversation information, assign a third conversation topic identifier 305 to the fourth conversation information, assign a fourth conversation topic identifier 307 to the fifth conversation information, and assign the first conversation topic identifier 301 to the sixth and seventh conversation information. For example, the first, second, sixth, and seventh conversation information may correspond to the same (or similar) conversation topic. The processor 120 may distinguish whether conversation context is maintained or changed based on the conversation topic identifier. The processor 120 may identify a relationship between user queries (or conversation information) based on a conversation topic identifier.

For example, when receiving the sixth user query (e.g., Busan travel recommendation), the processor 120 may determine the sixth user query as the first conversation topic identifier 301 based on the sixth user query. In this case, the processor 120 may use other conversation information (e.g., first conversation information and second conversation information) included in the first conversation topic identifier 301 when requesting a response to the sixth user query. When there is previous conversation information having the same conversation topic identifier as the first conversation topic identifier 301, the processor 120 may analyze the first conversation information, the second conversation information, and the sixth user query corresponding to the first conversation topic identifier 301 using the generative artificial intelligence (AI) engine so as to determine (or understand) the user's intention and the conversation context, and may generate, based on the determination result, a sixth response to the sixth user query. The generative AI engine may be included in the electronic device 101 and may be periodically updated. For example, the generative AI engine may be trained with user queries and responses to the user queries, and generate, based on the learned content, a response to a user query received from the user.

Alternatively, when previous conversation information having the conversation topic identifier as the first conversation topic identifier 301 does not exist, the processor 120 may transmit the first conversation information, the second conversation information, and the sixth user query to an intelligent server (e.g., the server 108 in FIG. 1 or generative artificial intelligence system in FIG. 2) via a communication module (e.g., the communication module 190 in FIG. 1), and may receive a sixth response to the sixth user query from the server 108. The server 108 may analyze the first conversation information, the second conversation information, and the sixth user query to determine (or understand) the user's intention and the conversation context, and may generate, based on the determination result, the sixth response to the sixth user query.

The display module 160, the processor 120, and the memory 130 according to an embodiment of the disclosure may be included, and instructions stored in the memory may, when executed by the processor, cause the electronic device to receive a user query via a voice assistant, to identify previous conversation information having a conversation topic associated with the user query, to display a previous conversation retrieval object on the display when the identified previous conversation information exists, to identify whether a user input selecting the previous conversation retrieval object is detected, and to provide a response based on the identified previous conversation information and the user query when the user input is detected.

The instructions, when executed by the processor, may cause the electronic device to determine whether a previous conversation topic associated with the user query exists, and when a previous conversation topic associated with the user query exists, to display conversation information corresponding to a conversation topic identifier associated with the previous conversation topic on the display, and to transmit, to a server, the user query and the conversation information together.

The instructions, when executed by the processor, may cause the electronic device to transmit the user query to a server when the identified previous conversation information does not exist, and to obtain a response to the user query from the server, and provide the response.

The instructions, when executed by the processor, may cause the electronic device to analyze a previous user query and a response corresponding to the previous user query, to group, based on an analysis result, conversation information corresponding to the same conversation topic, to assign a conversation topic identifier to the grouped conversation information, and to identify a conversation topic identifier associated with the user query and determine whether the user query is associated with previous conversation information.

The instructions, when executed by the processor, may cause the electronic device to provide the previous conversation information when the user input is detected, and to provide a list that summarizes each previous conversation information when a plurality of previous conversation information exists, and to provide previous conversation information selected by a user from the list.

The instructions, when executed by the processor, may cause the electronic device to detect a user input requesting conversation history information, to provide, based on the user input, a conversation history list that summarizes each conversation information, and to provide conversation information selected by a user from the conversation history list.

The instructions, when executed by the processor, may cause the electronic device to identify whether a response of the selected conversation information is associated with a time and a position and, based on a current time and a current position of the electronic device, to update the identified response.

The instructions, when executed by the processor, may cause the electronic device to display an original response of the identified response together with the updated response.

The instructions, when executed by the processor, may cause the electronic device to receive, from the user, a selection of a previous user query in conversation history information and, based on a current time and a current position of the electronic device, to perform a task for the selected user query.

The instructions, when executed by the processor, may cause the electronic device to not perform a task for the user query when the user query is the same as a previous user query included in conversation history information, and to search for a response to the previous user query from the memory, and to provide the retrieved response.

The instructions, when executed by the processor, may cause the electronic device to generate a summary keyword based on a user query and a response to the user query included in conversation history information, to provide a summary keyword based on a scroll position when a scroll input is detected in the conversation history information, and to provide conversation information corresponding to the summary keyword when the summary keyword is selected.

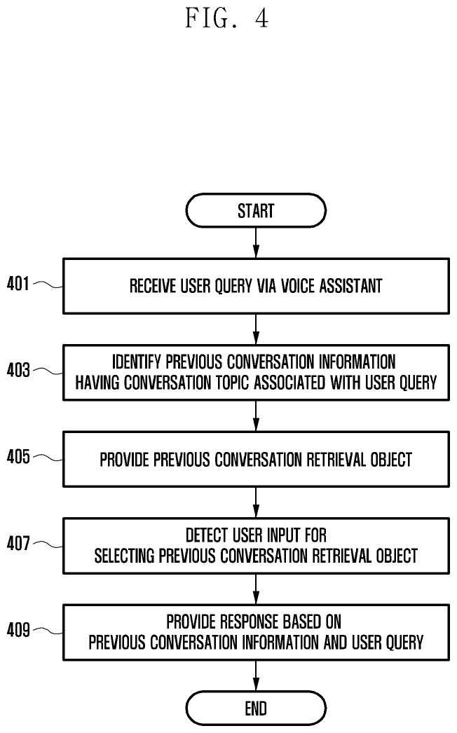

FIG. 4 is a flowchart 400 illustrating an operation method of an electronic device according to an embodiment of the disclosure.

Referring to FIG. 4, in operation 401, a processor (e.g., the processor 120 of FIG. 1) of an electronic device according to an embodiment (e.g., the electronic device 101 of FIG. 1) may receive a user query via a voice assistant. The voice assistant may collect and provide customized information to a user based on an artificial intelligence (AI) engine and voice recognition, and perform various tasks, such as schedule management, e-mail transmission, and restaurant reservation according to the user's voice commands. For example, in order to call the voice assistant, the user may utter a predetermined voice call word (e.g., Hi Bixby) or may press a button associated with the voice assistant. When a voice call word is detected via a microphone (e.g., the input module 150 in FIG. 1), the processor 120 may execute the voice assistant application and receive a user query. Alternatively, the processor 120 may execute the voice assistant application when a button (e.g., software button or physical button) for calling the voice assistant is selected. When the button is selected, the processor 120 may display a keypad on an execution screen of the executed voice assistant application.

According to an embodiment of the disclosure, when the voice assistant is called by a button, the voice assistant may operate in a text-based manner (e.g., a keypad display), or when the voice assistant is called by a voice, the voice assistant may operate in a voice-based manner (e.g., voice command reception), but is not limited thereto.

Upon receiving the user query, the processor 120 may display text corresponding to the user query on an execution screen of the voice assistant application. The user query may be a voice command acquired via a microphone, or may be text acquired via a keypad displayed on the execution screen of the executed voice assistant application. For example, when the user query is a voice command, the processor 120 may convert the voice command to text (speech to text) and display the text on the execution screen of the voice assistant application.

According to an embodiment of the disclosure, the processor 120 may determine a conversation topic whenever a user query is received, and determine a conversation topic identifier based on the determined conversation topic. Therefore, the conversation topic is the same, the same conversation topic identifier may be assigned. The processor 120 may determine (or assign or allocate) a conversation topic identifier with regard to the user query.

In operation 403, the processor 120 may identify previous conversation information having a conversation topic associated with the user query. The previous conversation information may include conversation information included in a conversation session existing before the user query. Once a conversation session is started (or opened), all user queries received within a specified time may be included in the same conversation session. Termination of the conversation session may not be limited to a specified time. The voice assistant may be forcibly terminated in response to a user's request while the conversation session is maintained, or the conversation session may be terminated when the voice assistant application is not used for a specified time.

When the voice assistant is called, a conversation session (e.g., first conversation) may be opened, a conversation identifier (e.g., first conversation identifier) may be assigned, and a conversation with the voice assistant may be initiated based on a user query. The opened conversation session may be maintained for a specified time (e.g., 1 day, 3 days, 7 days) if not forcibly terminated by the user. The meaning of maintaining a conversation session for a specified time may mean that although there is no conversation for the specified time (e.g., 24 hours) after the last conversation, the conversation session is maintained for 24 hours from the last conversation. Alternatively, the meaning of maintaining a conversation session for a specified time may mean that the conversation session is maintained for the specified time from the start time of the conversation session.

When the conversation session is maintained, the processor 120 may store the user query and the response to the user query included in the conversation session in memory (e.g., the memory 130 in FIG. 1) as previous conversation information. When a new user query is received while the conversation session is maintained or the voice assistant is called (or re-called), the processor 120 may process the same as a conversation included in the conversation session. For example, the processor 120 may transmit, to a server, conversation information corresponding to the same conversation topic identifier as an input user query, together with the user query, so as to receive a response continuous with a previous conversation.

The processor 120 may identify previous conversation information having a conversation topic associated with the user query, when the user query is detected within the specified time (e.g., before the conversation session is terminated or before a new conversation session is started). However, after the specified time expires (e.g., after the conversation session is terminated), when the user query is detected, the processor 120 may be incapable of identifying the previous conversation information. When the specified time elapses, the processor 120 may terminate the conversation session and delete the previous conversation information included in the conversation session. After the specified time elapses, when the voice assistant is called, a new conversation session (e.g., second conversation) may be opened, a new conversation identifier (e.g., second conversation identifier) may be assigned, and a conversation with the voice assistant may be initiated based on a user query.

According to an embodiment of the disclosure, some of the deleted previous conversation information may be stored in the memory 130 as conversation history information. The processor 120 may not store conversation information regarding a one-time user query (e.g., screen capture and today's date?) or a single-turn user query (e.g., configure a timer) when storing a conversation history.

In operation 405, the processor 120 may display a previous conversation retrieval object. The previous conversation information having a conversation topic associated with the user query may be the one to which the same conversation topic identifier as the user query is assigned. When previous conversation information having a conversation topic associated with the user query exists, the processor 120 may display the previous conversation retrieval object on a display (e.g., the display module 160 in FIG. 1). For example, the processor 120 may display the previous conversation retrieval object on an execution screen of the voice assistant application. The previous conversation retrieval object may include at least one of text, image, video, or audio.

In operation 407, the processor 120 may detect a user input selecting the previous conversation retrieval object. The user input may be an input selecting the previous conversation retrieval object and performing dragging (or swiping, scrolling). When a user input selecting the previous conversation retrieval object is detected, the processor 120 may display the previous conversation information on the display module 160.

In operation 409, when the user input is detected, the processor 120 may provide a response based on the previous conversation information and the user query. The previous conversation information may be a conversation temporally preceding the user query, to which the same conversation topic identifier as the user query is assigned. In order to determine the user's intention or the conversation context with regard to a user query, it may be helpful to analyze the conversation context before and after the user query. In addition, transmitting all previous conversation information with different user queries and conversation topics to the server 108 every time a user query is input may slow down the processing speed and may be unnecessary. The processor 120 may transmit the user query and the previous conversation information to an intelligent server (e.g., the server 108 in FIG. 1, and generative AI system in FIG. 2). The server 108 may generate a response to the user query based on the user query and the conversation information.

According to an embodiment of the disclosure, the processor 120 may determine a conversation topic identifier for the user query, and determine, based on the conversation topic identifier, whether it is processible by the electronic device 101. When there is previous conversation information having a conversation topic identifier that is the same as the conversation topic identifier for the user query and is processible by the electronic device 101, the processor 120 may generate a response to the user query using the generative artificial intelligence engine. When there is no previous conversation information having the same conversation topic identifier as the conversation topic identifier for the user query, the processor 120 may transmit the user query and the displayed conversation information to the server 108 so as to request a response to the user query.

When the user input is not detected, the processor 120 may transmit the user query to the server 108. For example, the user may want to receive only a response corresponding to the current user query without retrieving previous conversation information if the user determines that the user query is irrelevant to the context of the conversation (e.g., different conversation topic). When there is no request for retrieving a previous conversation from the user, the processor 120 may transmit only the user query to the server 108. For example, although other conversation information exists within the same conversation session as the user query, if the conversation information is irrelevant to the user query, it may not be transmitted to the server 108 since it is unnecessary information. By transmitting only the information needed to generate a response to the user query to the server 108, the processor 120 may increase a processing speed.

The processor 120 may acquire a response from the server 108 and provide the same to the user. The processor 120 may receive a response to the user query from the server 108 via the communication module 190, and display an execution screen of the voice assistant application including the received response on the display module 160. The response may include at least one of text, image, video, or audio. Alternatively, the processor 120 may convert the received response (e.g., text) into voice (e.g., text to speech) and output the voice to a speaker (e.g., the sound output module 155 in FIG. 1).

The processor 120 may determine whether there is conversation information to which the same conversation topic identifier as the determined conversation topic identifier is assigned among previous conversation information. When other conversations having the same conversation topic as the current user query exists, the processor 120 may transmit same to the server 108, thereby helping the server 108 recognize the user's intention or conversation context.

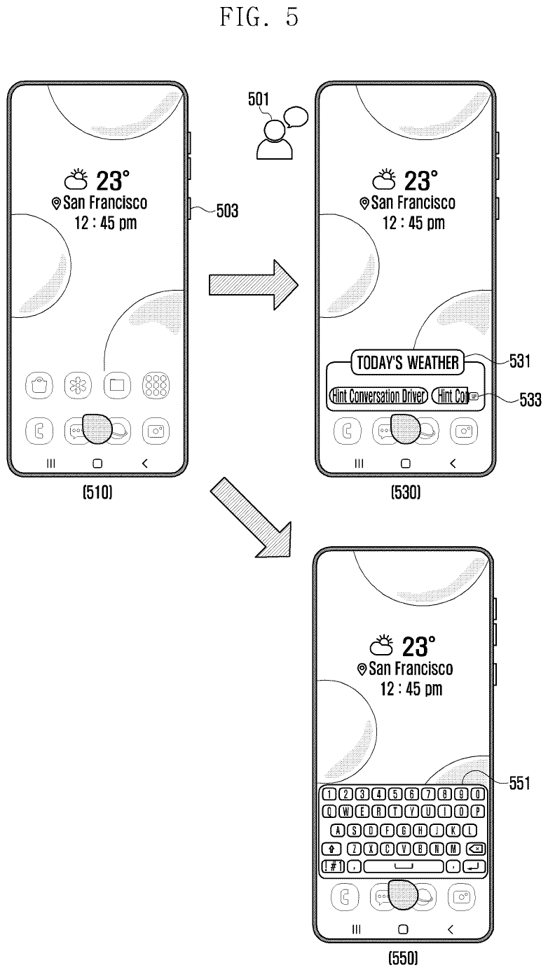

FIG. 5 is a diagram illustrating calling a voice assistant in an electronic device according to an embodiment of the disclosure.

Referring to FIG. 5, a processor (e.g., the processor 120 in FIG. 1) of an electronic device (e.g., the electronic device 101 in FIG. 1) according to an embodiment may display a first user interface 510 on a display (e.g., the display module 160 in FIG. 1). The processor 120 may detect a user input calling a voice assistant (e.g., executing a voice assistant application) while displaying the first user interface 510. For example, when a voice call word 501 is detected via a microphone (e.g., the input module 150 in FIG. 1), the processor 120 may execute the voice assistant application. A second user interface 530 may display an execution screen of the voice assistant application on the display module 160 when the voice assistant application is executed by the voice call word 501. The second user interface 530 may include a user query 531 of “today's weather” and a keypad switching button 533. The processor 120 may receive a user query 531 after the voice call word, convert the user query 531 to text (today's weather), and display the text. The keypad switching button 533 may be selected when a user wants to input a user query via a keypad The processor 120 may display the keypad as shown in a third user interface 550, when the keypad switching button 533 is selected.

Alternatively, the processor 120 may execute the voice assistant application when the voice assistant and a button 503 are selected. The third user interface 550 may display an execution screen of the voice assistant application on the display module 160 when the voice assistant application is executed by the button 503. The third user interface 550 may provide the execution screen of the voice assistant application together with a keypad 551 in order to receive a user query from the user.

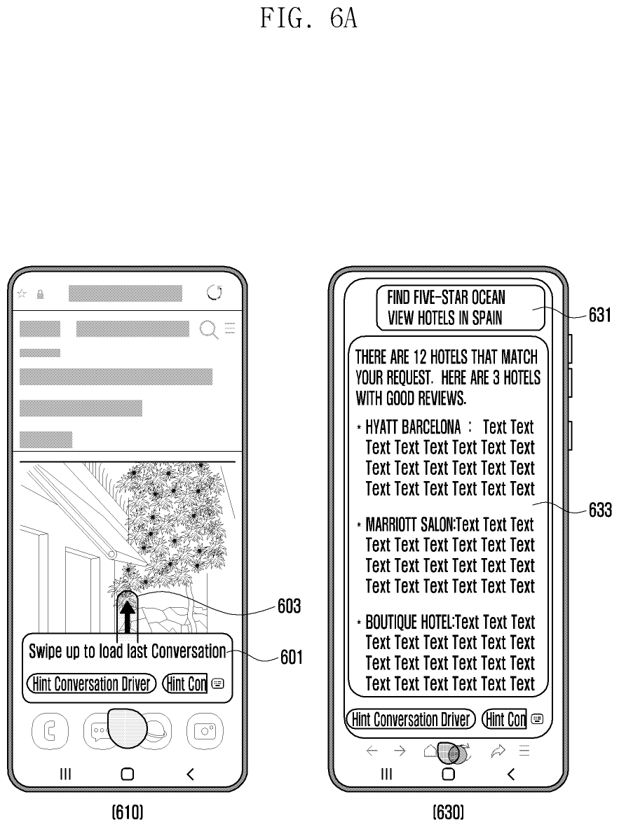

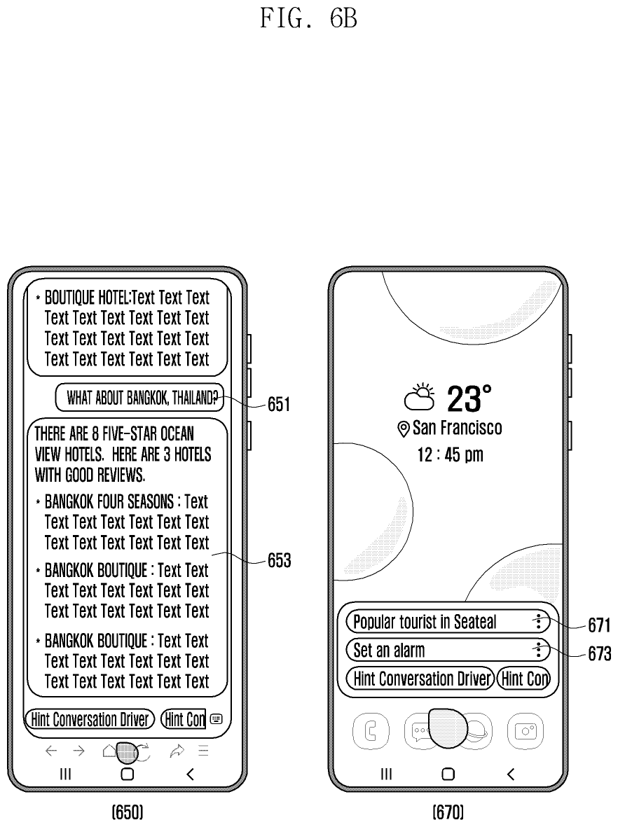

FIGS. 6A and 6B are diagrams illustrating retrieving previous conversation information in an electronic device according to various embodiments of the disclosure.

Referring to FIG. 6A, a processor (e.g., the processor 120 in FIG. 1) of an electronic device (e.g., the electronic device 101 in FIG. 1) according to an embodiment may display a first user interface 610 for receiving a user input requesting previous conversation information on a display (e.g., the display module 160 in FIG. 1). The processor 120 may detect a user input calling the voice assistant (e.g., executing the voice assistant application). The user input may be uttering a specified voice call word or pressing a specified button. The processor 120 may identify previous conversation information when the voice assistant is called. The previous conversation information may include content of a conversation with the voice assistant during a specified time.

When the voice assistant is called, a conversation session (e.g., first conversation) may be opened, a conversation identifier (e.g., first conversation identifier) may be assigned, and a conversation with the voice assistant may be initiated based on a user query. The opened conversation session may be maintained for a specified time (e.g., 1 day, 3 days, 7 days) if not forcibly terminated by a user. When the conversation session is maintained, the processor 120 may store a user query and a response to the user query included in the conversation session in memory (e.g., memory 130 in FIG. 1) as previous conversation information. When a new user query is received while the conversation session is maintained or the voice assistant is called (or re-called), the processor 120 may process the same as a conversation included in the conversation session.

The first user interface 610 may display a previous conversation retrieval object 601. The processor 120 may receive a first user input 603 for selecting the previous conversation retrieval object 601 in the first user interface 610. When the user wants to continue a conversation from the previous conversation, the user may select and drag the previous conversation retrieval object 601. The first user input 603 may be to drag (or scroll or swipe) upward after selecting the previous conversation retrieving object 601. When the first user input 603 is detected in the first user interface 610, the processor 120 may display the second user interface 630 on the display module 160. The second user interface 630 may include previous conversation information including a user query 631 and a response 633 to the user query 631. While the second user interface 630 is displayed, the processor 120 may receive a user query from the user.

Referring to FIG. 6B, a third user interface 650 may include a user query 651 and a response 653 to the user query 651. The response 653 may be generated based on the user query 651 and the previous conversation information. The processor 120 may analyze the user query 651 and the previous conversation information to determine (or understand) the user's intention and conversation context, and generate, based on the determination result, a response 653 to the user query 651. Alternatively, the processor 120 may transmit the user query 651 and the previous conversation information to an intelligent server (e.g., the server 108 in FIG. 1 or generative artificial intelligence system in FIG. 2), and receive the response 653 to the user query 651 from the server 108. The processor 120 may analyze the user query 651 and the previous conversation information to determine (or understand) the user's intention and conversation context, and generate, based on the determination result, the response 653 to the user query 651.

When a plurality of previous conversation information exists, the processor 120 may display a fourth user interface 670 including a previous conversation list on the display module 160. The fourth user interface 670 may include first previous conversation information 671 and second previous conversation information 673. When providing the previous conversation list, the processor 120 may summarize and provide the previous conversation information. The first previous conversation information 671 may include only one user query and one response for the user query. Alternatively, the previous conversation list may be provided for each conversation topic. The first previous conversation information 671 may include multiple user queries and respective responses to the user queries. The processor 120 may display the previous conversation list such that a recent previous conversation is displayed on the upper side, a previous conversation with a larger amount of previous conversation information in a conversation topic is displayed on the upper side, or only several pieces of previous conversation information ranked high are included. When the previous conversation information is selected in the previous conversation list, the processor 120 may display the selected previous conversation information on the display module 160. For example, when the first previous conversation information 671 is selected in the previous conversation list, the processor 120 may display the first previous conversation information 671.

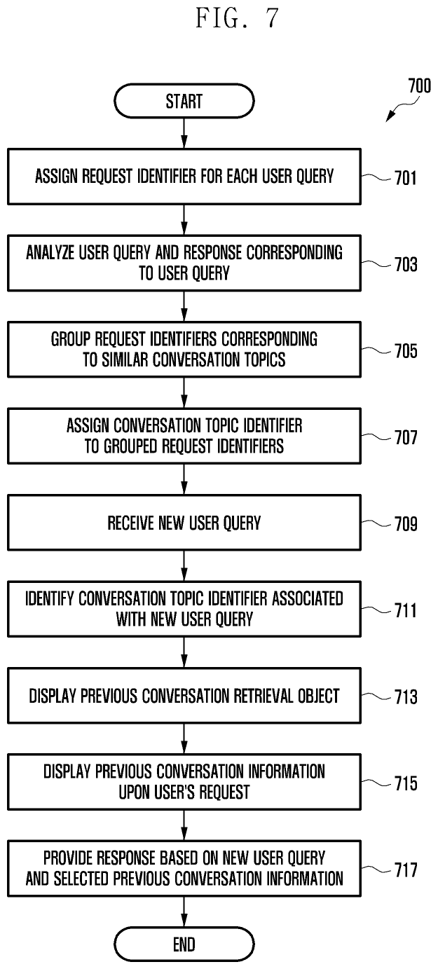

FIG. 7 is a flowchart 700 illustrating a method of providing previous conversation information in an electronic device according to an embodiment of the disclosure.

Referring to FIG. 7, in operation 701, a processor (e.g., the processor 120 in FIG. 1) of an electronic device (e.g., the electronic device 101 in FIG. 1) according to an embodiment may assign a request identifier for each user query. The user query may be a voice command obtained via a microphone (e.g., the input module 150 in FIG. 1) or text obtained via a keypad displayed on an execution screen of a voice assistant application. When the voice assistant is called, the processor 120 may execute the voice assistant application, start a conversation session, and assign a request identifier for each user query within the same conversation session. For example, the processor 120 may assign a first request identifier (request ID) to a first received user query in a first conversation session (e.g., first conversation identifier (conversation ID)), assign a second request identifier to a second received user query, and assign a third request identifier to a third received user query. A user query received within a specified time is processed as the same conversation session, and may be processed a new conversation session after the specified time elapses. For example, after the first conversation session terminated, the processor 120 may start a second conversation session when the voice assistant is called, and may assign a first request identifier to a first received user query in the second conversation session (e.g., second conversation identifier) and assign a second request identifier to a second received user query.

In operation 703, the processor 120 may analyze the user query and a response corresponding to the user query. The processor 120 may analyze the user query and generate a response corresponding to the user query. The processor 120 may display the generated response as text on a display (e.g., the display module 160 in FIG. 1) or output the same as audio via a sound output module (e.g., the sound output module 155 in FIG. 1). Alternatively, the processor 120 may transmit the user query to an intelligent server (e.g., the server 108 in FIG. 1 or generative artificial intelligence system in FIG. 2), obtain a response to the user query from the server 108, and provide the response to the user.

In operation 705, the processor 120 may group request identifiers corresponding to similar (or identical) conversation topics. The processor 120 may store a user query and a response to the user query as conversation information in memory (e.g., the memory 130 in FIG. 1). The processor 120 may group the conversation information corresponding to similar or identical conversation topics.

In operation 707, the processor 120 may assign a conversation topic identifier (conversation topic ID) to the grouped request identifiers. The conversation topic identifier may be to classify a user query based on a conversation topic. The processor 120 may manage the conversation information corresponding to the same conversation topic by using the conversation topic identifier. For example, although a user query or the content included in the user query is different, when the conversation topic is the same, the same conversation topic identifier may be determined (assigned or allocated).

In operation 709, the processor 120 may receive a new user query. When the new user query is a voice command, the processor 120 may convert the voice command to text (speech to text) and display the text on an execution screen of the voice assistant application.

In operation 711, the processor 120 may identify a conversation topic identifier for the new user query. Based on a user query, the processor 120 may determine a conversation topic identifier. According to an embodiment of the disclosure, when the conversation topic identifier is determined, the processor 120 may determine whether it is processable by the electronic device 101.

In operation 713, the processor 120 may display a previous conversation retrieval object on the display module 160. Based on the identified conversation topic identifier, the processor 120 may determine whether the new user query is associated with a previous conversation topic. The processor 120 may identify whether conversation information of the same (or similar) conversation topic as the new user query exists in a conversation session that the new user query belongs to. The processor 120 may display the previous conversation retrieving object when conversation information assigned with the same conversation topic identifier exists. The previous conversation retrieval object may include at least one of text, image, video, or audio. According to an embodiment of the disclosure, the processor 120 may display, on the display module 160, a previous conversation list distinguished by a conversation topic identifier, such as the first previous conversation information 671 and the second previous conversation information 673 in FIG. 6B.

In operation 715, upon a user's request, the processor 120 may display previous conversation information. When the previous conversation retrieval object is selected, the processor 120 may display previous conversation information. The processor 120 may display the previous conversation information when a user input dragging (or scrolling, swiping) upwards after selecting the previous conversation retrieval object is detected. Here, the previous conversation information may be conversation information having the same conversation topic as the new user query.

In operation 717, based on the new user query and the selected previous conversation information, the processor 120 may provide a response. The processor 120 may transfer conversation information selected by the user among the displayed previous conversation information or a conversation topic identifier of the conversation information to a server so as to request the server to generate a response. In order to determine the user's intention or conversation context with regard to a user query, it may be helpful to analyze the conversation context before and after the user query. In addition, transmitting all previous conversation information with different user queries and conversation topics to the server 108 every time a user query is input may slow down the processing speed and may be unnecessary. The processor 120 may transmit the user query and the previous conversation information to an intelligent server (e.g., the server 108 in FIG. 1, and generative AI system in FIG. 2). The server 108 may generate a response to the user query based on the user query and the conversation information.

According to an embodiment of the disclosure, when previous conversation information having the same conversation topic identifier as the conversation topic identifier for the new user query exists, the processor 120 may generate a response to the user query and the previous conversation information by using the generative artificial intelligence engine. When no previous conversation information having the same conversation topic identifier as the conversation topic identifier for the new user query exists, the processor 120 may transmit the new user query to the server 108 so as to request a response to the user query.

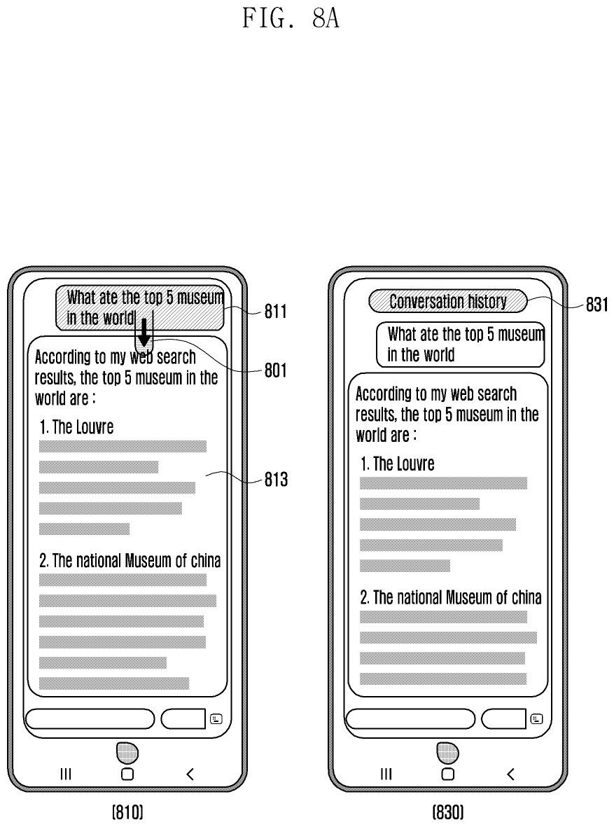

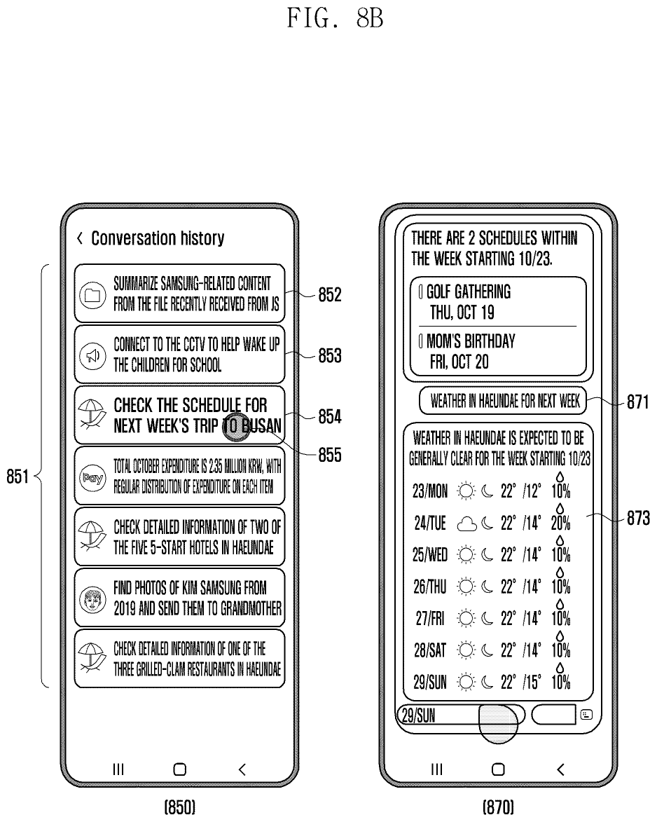

FIG. 8A is a diagram illustrating retrieving a conversation history in an electronic device according to an embodiment of the disclosure.

Referring to FIG. 8A, a processor (e.g., the processor 120 in FIG. 1) of an electronic device (e.g., the electronic device 101 in FIG. 1) according to an embodiment may display a first user interface 810 on a display (e.g., the display module 160 in FIG. 1). The first user interface 810 may include a user query 811 and a response 813 to the user query 811. The processor 120 may detect a user input 801 for retrieving a previous conversation history while displaying the first user interface 810. The processor 120 may display a second user interface 830 in response to the user input 801. The second user interface 830 may include a notification 831 indicating that a conversation history exists. The conversation history may include conversation information included in a conversation session before receiving the user query 811. When the notification 831 is selected, the processor 120 may search for the conversation history stored in memory (e.g., the memory 130 in FIG. 1). The user query 811 may be received after termination of the previous conversation session. The previous conversation session may include a conversation session that elapses a specified time before the voice assistant is called. Alternatively, the previous conversation session may include a conversation session in which the voice assistant application is forcibly terminated by a user.

FIG. 8B is a diagram illustrating providing conversation information via a conversation history summary list in an electronic device according to an embodiment of the disclosure.

Referring to FIG. 8B, when the notification 831 indicating that a conversation history exists is selected, the processor 120 may display a third user interface 850 including a conversation history summary list 851 on the display module 160. According to an embodiment of the disclosure, the processor 120 may maintain a conversation session during a specified time and store conversation information (e.g., a user query and a response to the user query) included in the conversation session as previous conversation information in the memory (e.g., the memory 130 in FIG. 1). The processor 120 may terminate the conversation session when the specified time elapses. When the conversation session is terminated, the processor 120 may store a portion of the previous conversation information as a conversation history in the memory 130. The processor 120 may not store conversation information regarding a one-time user query (e.g., screen capture and today's date?) or a single-turn user query (e.g., configure a timer) when storing a conversation history.

The conversation history summary list 851 may include a plurality of conversation summary information, and may include, for example, first conversation summary information 852, second conversation summary information 853, and third conversation summary information 854. The processor 120 may summarize and provide each conversation information when providing the conversation history summary list 851. The processor 120 may generate conversation summary information based on a user query and a response included in each conversation information.

When the third conversation summary information 854 is selected, the processor 120 may display a fourth user interface 870 on the display module 160. The fourth user interface 870 may include a user query 871 and a response 873 corresponding to the third conversation summary information 854.

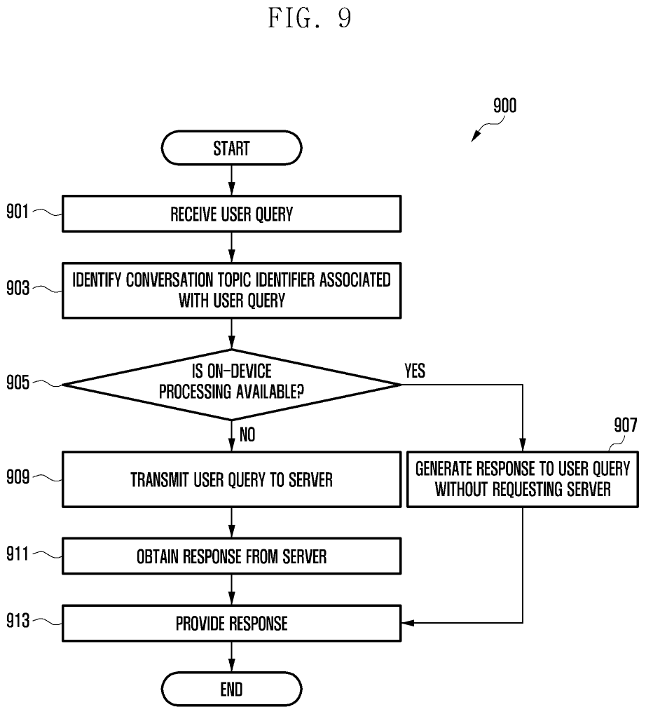

FIG. 9 is a flowchart 900 illustrating a method of providing a response based on a conversation topic associated with a user query in an electronic device according to an embodiment of the disclosure.

Referring to FIG. 9, in operation 901, a processor (e.g., the processor 120 of FIG. 1) of an electronic device according to an embodiment (e.g., the electronic device 101 of FIG. 1) may receive a user query. When a voice call word is detected via a microphone (e.g., the input module 150 in FIG. 1), the processor 120 may execute a voice assistant application and receive a user query. Alternatively, when a button for calling the voice assistant is selected, the processor 120 may execute the voice assistant application and receive the user query via a keypad displayed on an execution screen of the voice assistant application. The user query may be a voice command obtained via a microphone, or may be text obtained via a keypad displayed on an execution screen of the executed voice assistant application.

In operation 903, the processor 120 may identify a conversation topic identifier associated with the user query. The conversation topic identifier may be to manage conversation information corresponding to the same conversation topic. For example, although the user query or the content included in the user query is different, if the conversation topic is the same, the same conversation topic identifier may be determined (or assigned, allocated). For example, the conversation topic may be a large classification, such as a person, an object, or an animal, an intermediate classification of the object, such as a car or food, or a small classification of food, such as spaghetti or steak. The examples are provided to help in understanding the disclosure, and are not intended to limit the disclosure.

In operation 905, the processor 120 may determine whether performing on-device processing is available. Based on the conversation topic identifier associated with the user query, the processor 120 may determine whether on-device processing is available. On-device processing may refer to processing directly in the electronic device 101. The processor 120 may determine whether on-device processing is available by using a generative artificial intelligence engine. For example, when previous conversation information having the same conversation topic identifier as the user query exists, the processor 120 may determine that on-device processing is available. Alternatively, the processor 120 may determine that on-device processing is available when a response source for the user query corresponds to information stored (or registered) in the electronic device 101. For example, when a source (or task) of a response to a user query, such as “what is my schedule today?,” “configure a timer for 10 minutes,” or “send a message to Jack that I will be a little late” is information stored in the electronic device 101, the processor 120 may determine that on-device processing is available.

When on-device processing is available, the processor 120 may perform operation 907, and when on-device processing is unavailable, the processor 120 may perform operation 909.

When on-device processing is available, the processor 120 may generate a response to the user query without requesting a server in operation 907. The processor 120 may, by using the generative artificial intelligence engine, analyze the user query and previous conversation information having the same conversation topic identifier as the user query so as to determine (or understand) a user's intention and conversation context, and generate, based on the identification result, a response to the user query. Based on the user query and the previous conversation information having the same conversation topic identifier as the user query, the generative artificial intelligence engine may generate a response. In order to understand the user's intent and the conversation context regarding the user query, the previous conversation information may be useful. The generative artificial intelligence engine may generate a more accurate response to the user query by analyzing not only the current user query but also the previous conversation information together. After generating the response, the processor 120 may perform operation 913. When a plurality of previous conversation information exists, the processor 120 may provide a previous conversation list including the plurality of previous conversation information, and may receive a selection of a portion of the previous conversation information from the user. The processor 120 may analyze the selected previous conversation information together with the user query and may generate a more accurate response for the user query.

When on-device processing is unavailable, the processor 120 may transmit the user query to an intelligent server (e.g., the server 108 in FIG. 1 or generative artificial intelligence system in FIG. 2) via a communication module (e.g., the communication module 190 in FIG. 1) in operation 909. The server 108 may analyze the user query to determine (or understand) the user's intention and the conversation context, and generate a response to the user query, based on the determination result. When a plurality of previous conversation information exists, the processor 120 may provide a previous conversation list including the plurality of previous conversation information, and may receive a selection of a portion of the previous conversation information from the user. The processor 120 may transmit the previous conversation information selected by the user along with the user query to the intelligent server (e.g., the server 108 in FIG. 1 or generative artificial intelligence system in FIG. 2).

In operation 911, the processor 120 may obtain a response from the server 108. The processor 120 may receive the response to the user query from the server 108 via the communication module 190.

In operation 913, the processor 120 may provide the response. The processor 120 may display an execution screen of the voice assistant application including the response on the display module 160. The response may include at least one of text, image, video, or audio. Alternatively, the processor 120 may convert the received response (e.g., text) into voice (e.g., text to speech) and output the voice to a speaker (e.g., the sound output module 155 in FIG. 1).

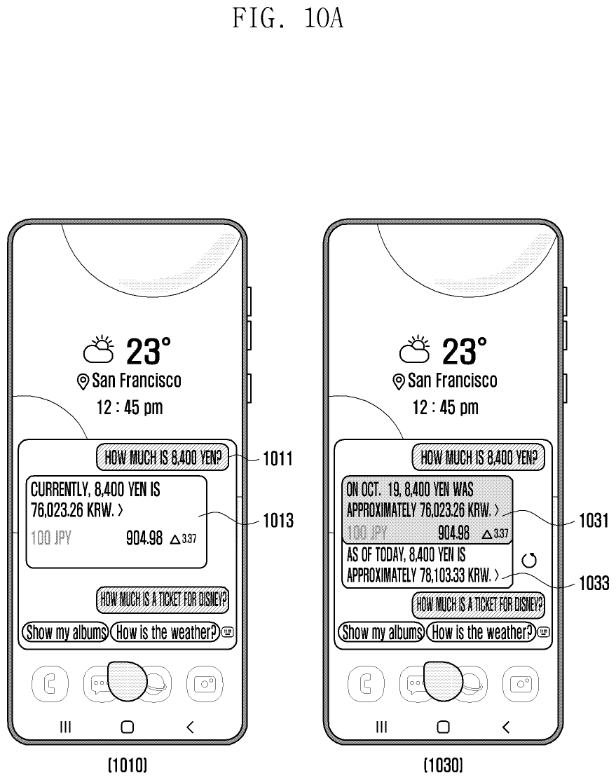

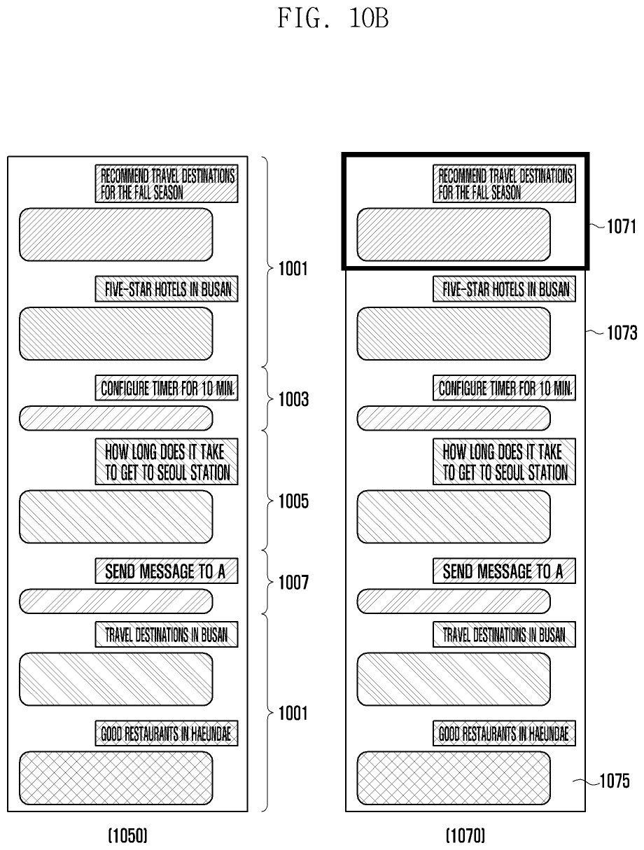

FIG. 10A is a diagram illustrating providing conversation history information in an electronic device according to an embodiment of the disclosure.

Referring to FIG. 10A, a processor (e.g., the processor 120 in FIG. 1) of an electronic device (e.g., the electronic device 101 in FIG. 1) according to an embodiment may display a first user interface 1010 on a display (e.g., the display module 160 in FIG. 1). The first user interface 1010 may be an execution screen of a voice assistant application and may include conversation information including a user query 1011 and a response 1013 to the user query 1011. The conversation information included in the first user interface 1010 may be stored as conversation history information when a conversation session is terminated.

Upon a user's request, when the conversation history information is requested, the processor 120 may display a second user interface 1030 on the display module 160. The second user interface 1030 may include conversation history information including a user query, the first response 1031 to the user query, and a response 1033. The conversation history information may be conversation information included in a terminated conversation session, and may be conversation information from three days before the current time. When a response in the conversation information needs to change depending on a state (e.g., time, position) of the electronic device 101, the processor 120 may update (or edit) the response based on the current time and provide the same as conversation history information. When a conversations history is requested by the user, the processor 120 may determine whether a response in the conversation history information requires modification by using a generative artificial intelligence engine, and when the response requires modification, provide modified conversation history information. The first response 1031 is the original response, and the second response 1033 may be an updated (or modified) response based on the current state of the electronic device 101. Alternatively, when response modification is required, the processor 120 may provide the first response 1031 and a response modification button, and when the response modification button is selected, the processor 120 may provide the second response 1033.

FIG. 10B is a diagram illustrating managing conversation history information in an electronic device according to an embodiment of the disclosure.

Referring to FIG. 10B, the processor 120 may delete conversation history information stored in memory (e.g., the memory 130 in FIG. 1) when a specified time elapses. Referring to a first diagram 1050, the processor 120 may assign a first conversation topic identifier 1001 to first and second conversation information, assign a second conversation topic identifier 1003 to third conversation information, assign a third conversation topic identifier 1005 to fourth conversation information, assign a fourth conversation topic identifier 1007 to fifth conversation information, and assign the first conversation topic identifier 1001 to sixth and seventh conversation information. For example, the first, second, sixth, and seventh conversation information may correspond to the same (or similar) conversation topic. The processor 120 may distinguish whether conversation context is maintained or changed based on a conversation topic identifier. The processor 120 may identify a relationship between user queries (or conversation information) based on a conversation topic identifier.

Referring to a second diagram 1070, based on a state (e.g., time, position) of the electronic device 101, the processor 120 may delete a portion of the conversation information. The processor 120 may delete, from the conversation history information, conversation information having low interconnection therebetween and having low validity at the current time. First conversation information 1071 may correspond to the same conversation topic as second conversation information 1073 and third conversation information 1075, but may have no relation to a specific region (e.g., Busan). The processor 120 may delete the first conversation information 1071.

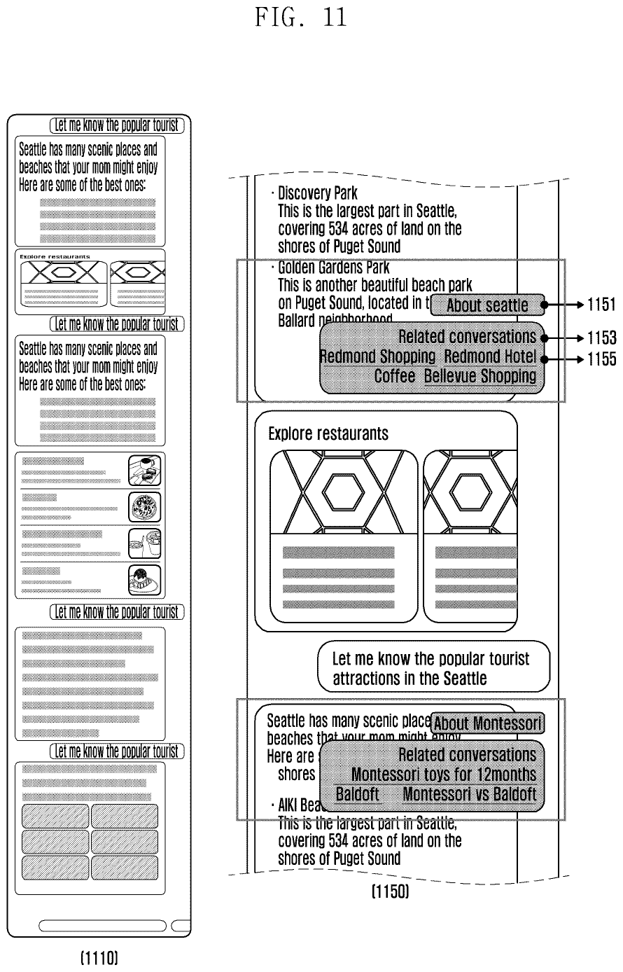

FIG. 11 is a diagram illustrating providing fast scrolling for a conversation history in an electronic device according to an embodiment of the disclosure.

Referring to FIG. 11, a processor (e.g., the processor 120 in FIG. 1) of an electronic device (e.g., the electronic device 101 in FIG. 1) according to an embodiment may provide fast scrolling for conversation information when providing conversation history information. Referring to a first diagram 1110, a plurality of conversation information may be stored in memory (e.g., the memory 130 in FIG. 1). When the amount of conversation history information is large, the processor 120 may provide a scroll bar on a display (e.g., the display module 160 in FIG. 1). In the case of handling scrolling, when conversation information is long, a user may have difficulty in identifying what the conversation information is. The processor 120 may provide fast scroll (or shortcut) information in the scroll bar. The fast scroll information may be to move (or jump) to corresponding conversation information and display the corresponding conversation information.

Referring to a second diagram 1150, the processor 120 may generate fast scroll information when a user query is different from previous conversation information. The processor 120 may extract keywords based on user queries and responses included in conversation information, and generate fast scroll information by combining the extracted keywords. For example, the processor 120 may provide first fast scroll information 1151, second fast scroll information 1153, or third fast scroll information 1155. When the first fast scroll information 1151 is selected, the processor 120 may move to and display conversation information corresponding to the first fast scroll information 1151.

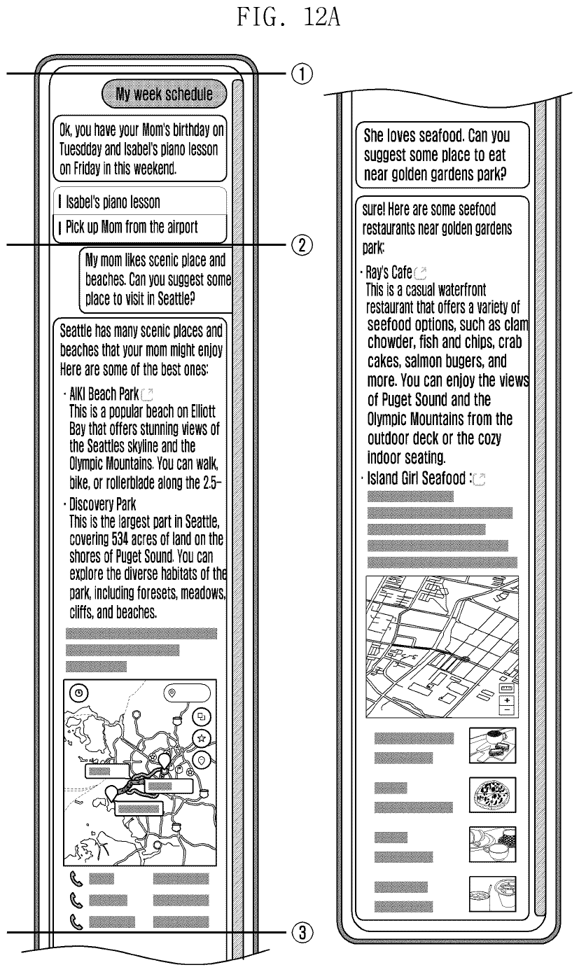

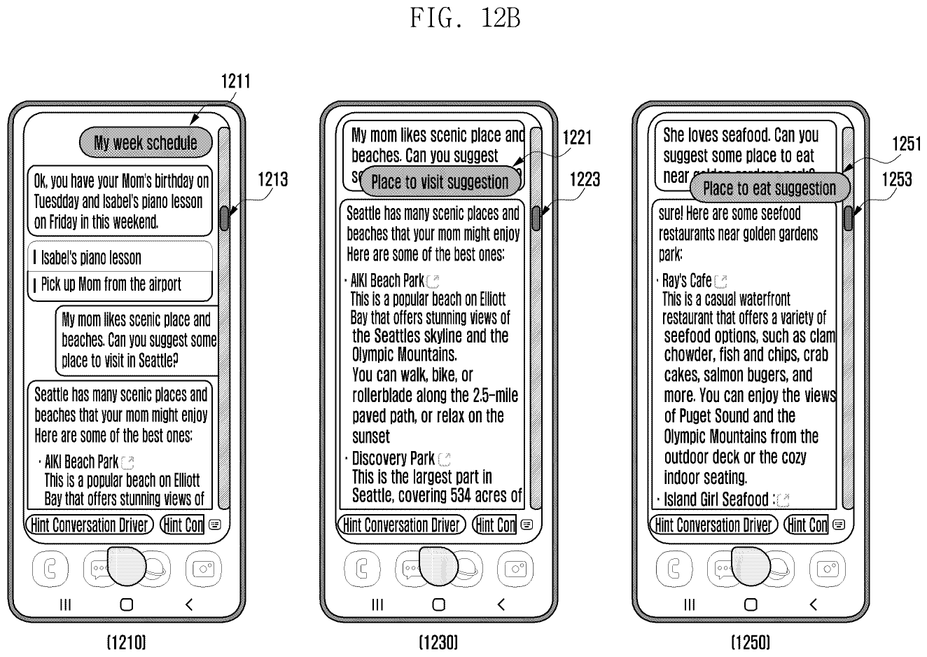

FIGS. 12A and 12B are diagrams illustrating providing fast scrolling for a conversation history in an electronic device according to various embodiments of the disclosure.

Referring to FIG. 12A, a processor (e.g., the processor 120 in FIG. 1) of an electronic device (e.g., the electronic device 101 in FIG. 1) according to an embodiment may store conversation history information including a response to a user query in memory (e.g., the memory 130 in FIG. 1). For example, the memory 130 may store first conversation information 1 including a first user query and a first response, second conversation information (2) including a second user query and a second response, and third conversation information 3 including a third user query and a third response. For reference, the second and third responses may be too long to be displayed entirely on a display (e.g., the display module 160 in FIG. 1).

Referring to FIG. 12B, based on a scroll position of a scroll bar, the processor 120 may provide different fast scroll information while providing conversation history information. For example, the processor 120 may display a first user interface 1210 including first fast scroll information 1211 on the display module 160. The first user interface 1210 may include the first fast scroll information 1211 generated based on a user query and a response, and a scroll object 1213. The first fast scroll information 1211 may be a summary keyword (or suggested keyword) for the first conversation information corresponding to a position of the scroll object 1213.

When the scroll object 1213 is moved, the processor 120 may display a second user interface 1230 on the display module 160. The second user interface 1230 may include second fast scroll information 1221, based on a position of a scroll object 1223. The second fast scroll information 1221 may be a summary keyword (or a suggested keyword) for the second conversation information corresponding to the position of the scroll object 1223. The second fast scroll information 1221 may differ from the first fast scroll information 1211.

When the scroll object 1223 is moved further downward, the processor 120 may display a third user interface 1250 on the display module 160. The third user interface 1250 may include third fast scroll information 1251 based on a position of a scroll object 1253. The third fast scroll information 1251 may be a summary keyword (or suggested keyword) for the third conversation information corresponding to a position of the scroll object 1253. The third fast scroll information 1251 may differ from the first fast scroll information 1211 or the second fast scroll information 1221.

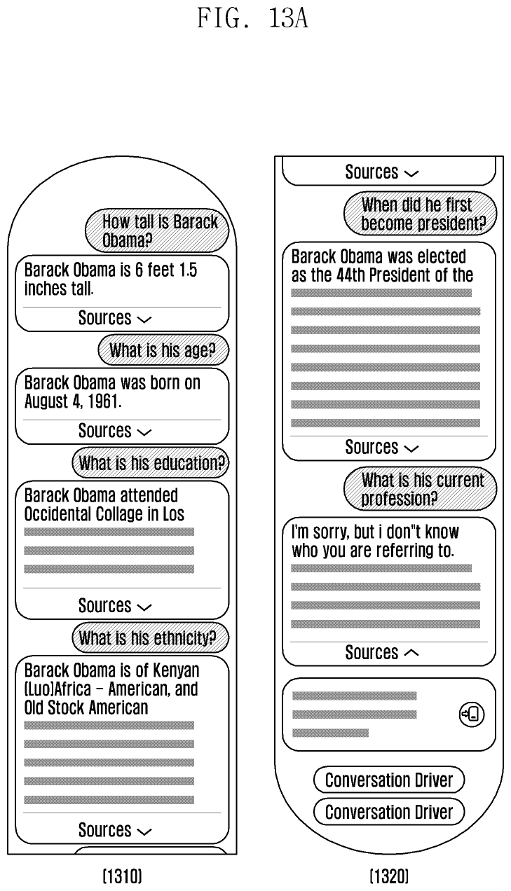

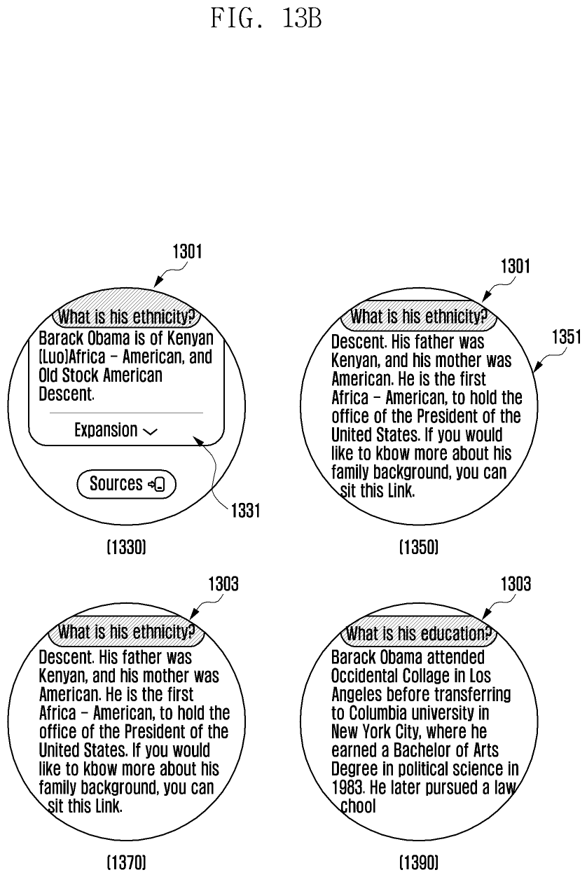

FIGS. 13A and 13B are diagrams illustrating providing previous conversation information based on a screen size in an electronic device according to various embodiments of the disclosure.

Referring to FIGS. 13A and 13B, a first diagram 1310 illustrates an example including previous conversation information (or conversation history information) including responses corresponding to a plurality of user queries. A second diagram 1320 may include previous conversation information (or conversation history information) including responses corresponding to a plurality of user queries. For example, when the electronic device (e.g., the electronic device 101 in FIG. 1) is a wearable device (e.g., watch), all of the previous conversation information may not be displayed on a screen of the wearable device. For example, a portion (e.g., response) of the previous conversation information may be off the screen of the wearable device. Since a size of the screen of the wearable device is small, it may be difficult to display a large amount of information at once.

In this instance, as in a first user interface 1330, a response expand object 1331 may be provided for a response to a user query 1301. When the response expand object 133 is selected, a response 1351 may be provided further, as in a second user interface 1350. In this instance, when a user scrolls in order to view the response 1351, the user query 1301 may be outside the size of the display of the wearable device. The user may not know what the response 1351 is for by looking at merely the response 1351. When the user query 1301 is off the screen, the processor (e.g., the processor 120 in FIG. 1) may maintain (e.g., floating) displaying the user query 1301.

Alternatively, the processor 120 may provide a summary keyword of the user query 1301 when the user query 1301 goes off the screen. A third user interface 1370 may include a response to a first summary query 1303 that summarizes multiple user queries (e.g., Who is Barack Obama and what is his ethnicity and education?). A fourth user interface 1390 may include a response to a second summary query 1305 that summarizes two user queries. The multiple user queries may include a first user query (e.g., “what's his ethnicity?”) and a second user query (e.g., “what's his education?”). When the response displayed on the screen corresponds to the first user query, a first summary query 1303 may be displayed. When the response displayed on the screen corresponds to the second user query among the multiple user queries, the processor 120 may display the second summary query 1305.

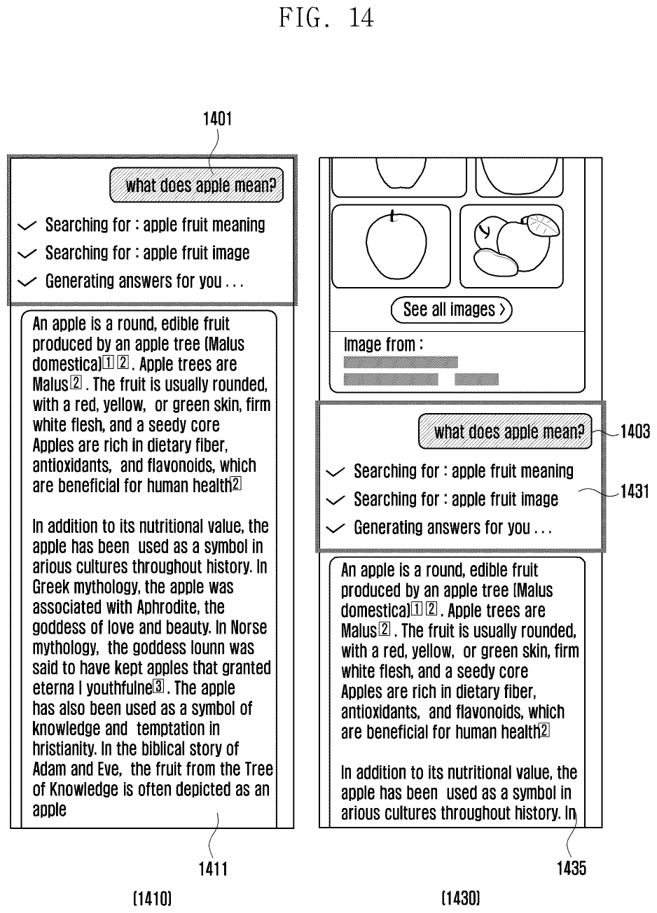

FIG. 14 is a diagram illustrating providing a previous response depending on a user query in an electronic device according to an embodiment of the disclosure.

Referring to FIG. 14, a processor (e.g., the processor 120 in FIG. 1) of an electronic device (e.g., the electronic device 101 in FIG. 1) according to an embodiment may utilize a previous response for the same user query. For example, a first diagram 1410 may include a first user query 1401 and a first response 1411 to the first user query 1401. The processor 120 may store the first user query 1401 and the first response 1411 as conversation history information in memory (e.g., the memory 130 in FIG. 1) when a conversation session is terminated. At a later time, a user may input a second user query 1403 that is the same as the first user query 1401. A second diagram 1430 may include the second user query 1403 and a second response 1435 to the second user query 1403. Upon receiving the second user query 1403, the processor 120 may search the memory 130 for conversation history information including a user query that is the same as (or similar to) the second user query 1403. The processor 120 may provide the second response 1435 that is the same as (or similar to) the first response 1411 when conversation history information including the user query that is the same as (or similar to) the second user query 1403. Alternatively, when providing the second response 1435, the processor 120 may also provide summary information 1431 of the first response 1411.

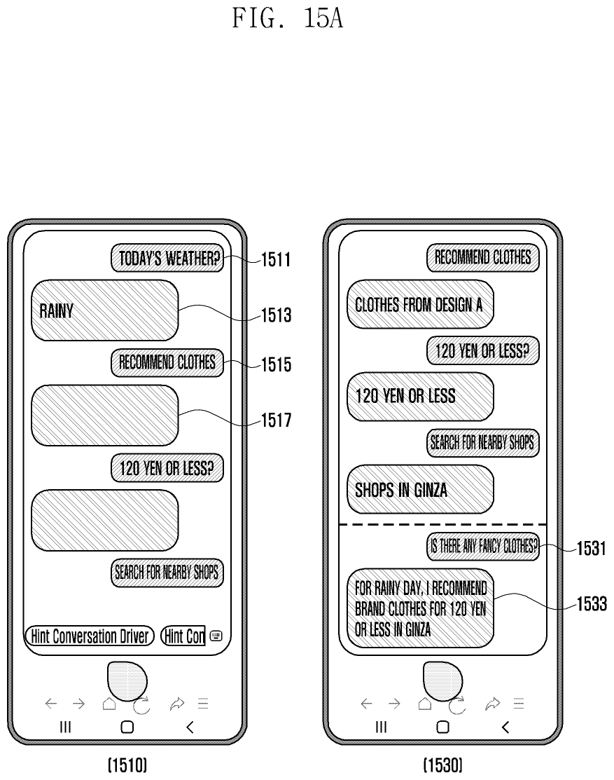

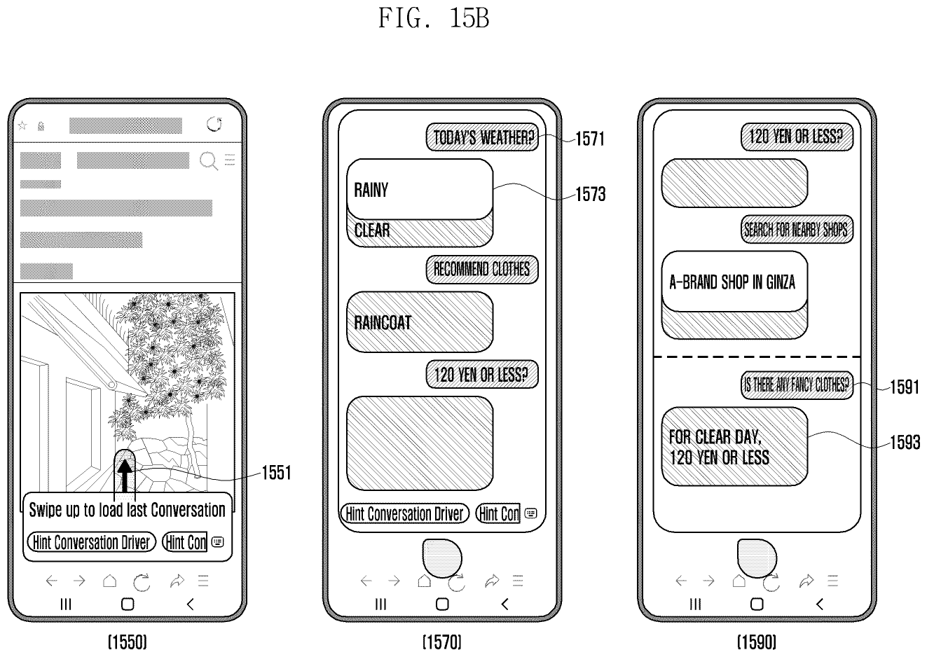

FIGS. 15A and 15B are diagrams illustrating providing previous conversation information differently depending on a current state of an electronic device according to various embodiments of the disclosure.

Referring to FIG. 15A, a processor (e.g., the processor 120 in FIG. 1) of an electronic device (e.g., the electronic device 101 in FIG. 1) according to an embodiment may have a conversation with a voice assistant at a first time. A first user interface 1510 may display first previous conversation information exchanged with the voice assistant at a first time. Referring to the first user interface 1510, the processor 120 may provide a first response 1513 to a first user query 1511 and provide a second response 1517 to a second user query 1515. Subsequently, when a third user query 1531 is received in the same conversation session as the second user query 1515, the processor 120 may display a second user interface 1530 on a display (e.g., the display module 160 in FIG. 1). Upon a user's request (e.g., selecting a previous conversation retrieval object), the processor 120 may retrieve the first previous conversation information that exists in the same conversation session.

A second user interface 1530 may include the first previous conversation information, a third user query 1531, and a third response 1533. Based on the first previous conversation information and the third user query 1531, the processor 120 may provide the third response 1533. The processor 120 may have difficulty in identifying the user's intention or conversation context only with the third user query 1531, but may identify previous conversation context by utilizing the first previous conversation information together with the third user query 1531, and then provide the third response 1533. The processor 120 may use “rainy day,” which is not included in the third user query 1531, as a keyword, and may more accurately provide a response that the user wants.

Referring to FIG. 15B, the user may call the voice assistant the day after the second user interface 1530 is displayed. The processor 120 may identify previous conversation information when the voice assistant is called at a second time that is after the first time. The previous conversation information may include conversation information included in a conversation session that exists before the voice assistant is called. When previous conversation information exists, the processor 120 may display the previous conversation retrieving object. A third user interface 1550 may include a previous conversation retrieval object 1553. The processor 120 may detect a user input 1551 for selecting the previous conversation retrieval object 1553 while displaying the third user interface 1550. In response to the user input 1551, the processor 120 may display a fourth user interface 1570 on the display module 160. The fourth user interface 1570 may include second previous conversation information.

The processor 120 may update (or modify) second previous conversation information, based on a state (e.g., time and position) of the electronic device 101. The second previous conversation information may provide a second response 1573 to a first user query 1571. In comparison of the first user interface 1510 and a fourth user interface 1570, the second response 1573 may further include “clear” as current weather. In addition, the processor 120 may update a third response 1593 to a third user query 1591 as in a fifth user interface 1590. In comparison of the second user interface 1530 and the fifth user interface 1590, the third response 1593 may include a result obtained by searching for clothes of 120 yen or less based on the current weather of “sunny day.” The processor 120 may delete a portion of the responses (e.g., rainy day) and replace the same with a new response (e.g., clear) as the time of the electronic device 101 changes. However, a response (e.g., 120 yen or less) that is not influenced by the time and position of the electronic device 101 may be maintained.

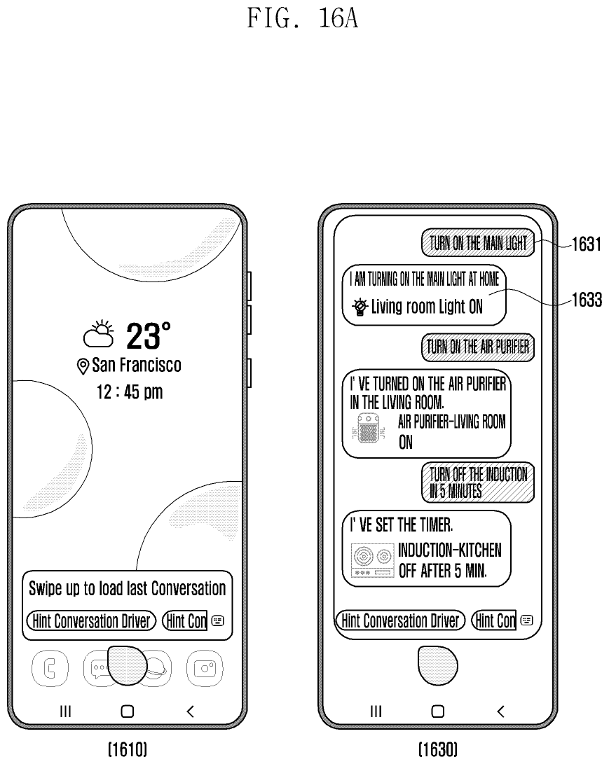

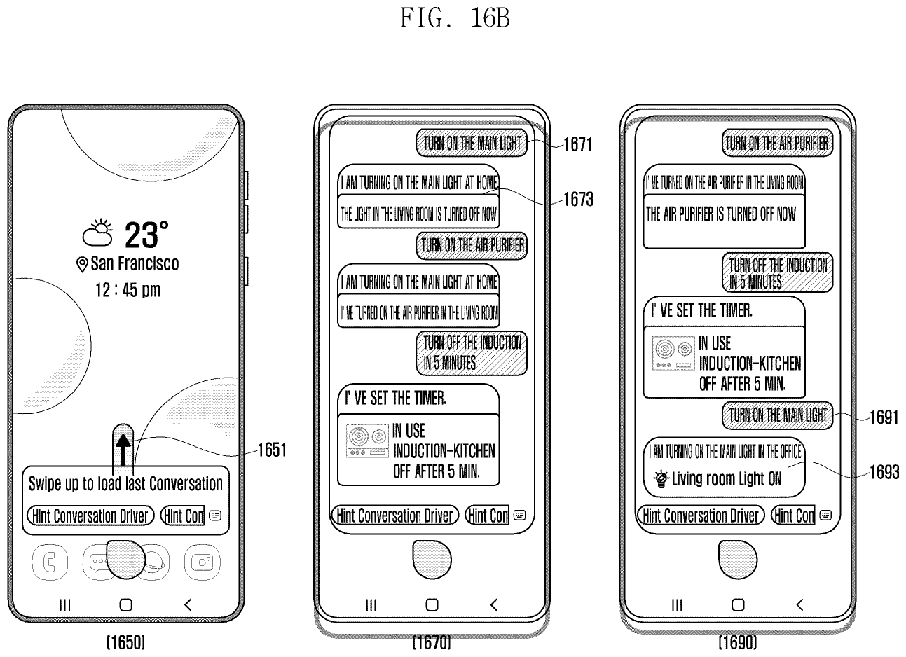

FIGS. 16A and 16B are diagrams illustrating performing a task with regard to a user query differently depending on a current state of an electronic device according to various embodiments of the disclosure.

Referring to FIG. 16A, a processor (e.g., the processor 120 in FIG. 1) of an electronic device (e.g., the electronic device 101 in FIG. 1) according to an embodiment may display a first user interface 1610 on a display (e.g., the display module 160 in FIG. 1) when a voice assistant is called in a first position (e.g., home). A first user interface 1610 may include a previous conversation retrieval object 1611. The processor 120 may display the previous conversation retrieval object in the case in which previous conversation information exists when the voice assistant is called. When a user query is received, the processor 120 may display a second user interface 1630 on the display module 160. The second user interface 1630 may include a first response 1633 to a first user query 1631. The first response 1633 may provide a task performance result after the processor 120 performs a first task (e.g., turning on the main lighting at home) for the first user query 1631. In addition, after providing the first response 1633, the processor 120 may receive second and third user queries, perform tasks corresponding thereto, and then provide task performance results as responses.

Referring to FIG. 16B, the user may call the voice assistant after the second user interface 1630 is displayed. The processor 120 may identify previous conversation information when the voice assistant is called in a second position (e.g., office) different from the first position. The previous conversation information may include conversation information included in a conversation session that exists before the voice assistant is called. When previous conversation information exists, the processor 120 may display the previous conversation retrieving object. A third user interface 1650 shows an example in which a user input 1651 for selecting the previous conversation retrieval object is detected. In response to the user input 1651, the processor 120 may display a fourth user interface 1670 on the display module 160. The fourth user interface 1670 may include previous conversation information. The previous conversation information may include a first user query 1671 and a second response 1673.

The processor 120 may display a fifth user interface 1690 when the first user query 671 is selected while the fourth user interface 1670 is displayed. The fifth user interface 1690 may include a second response 1693 to a second user query 1691. The second response 1693 may provide a task performance result after the processor 120 performs a second task (e.g., turning on the main lighting in an office) for the second user query 1691. For example, the processor 120 may perform different tasks and provide different responses with regard to the same user query, depending on a change in the state (e.g., position) of the electronic device 101. In comparison of the second user interface 1630 and the fifth user interface 1690, the second response 1693 may include a result of performing the second task based on the current position, which is an office. The processor 120 may perform the second task (e.g., turning on an office light) different from the first task (e.g., turning on a home light) as the position of the electronic device 101 changes.

A method of operating the electronic device 101 according to an embodiment of the disclosure may include an operation of receiving a user query via a voice assistant, an operation of identifying previous conversation information having a conversation topic associated with the user query, an operation of displaying a previous conversation retrieval object on the display module 160 of the electronic device when the identified previous conversation information exists, an operation of identifying whether a user input selecting the previous conversation retrieval object is detected, and an operation of providing a response based on the identified previous conversation information and the user query when the user input is detected.

The method may further include an operation of transmitting the user query to a server when the identified previous conversation information does not exist, and an operation of obtaining a response to the user query from the server and providing the response.

The method may further include an operation of analyzing a previous user query and a response corresponding to the previous user query, an operation of grouping conversation information corresponding to the same conversation topic based on the analysis result, an operation of assigning a conversation topic identifier to the grouped conversation information, and an operation of identifying a conversation topic identifier associated with the user query and determining whether the user query is associated with previous conversation information.

The method may further include an operation of providing the previous conversation information when the user input is detected, and an operation of providing a list that summarizes each previous conversation information when a plurality of previous conversation information exists, and providing previous conversation information selected by a user from the list.

The method may further include an operation of detecting a user input that requests conversation history information, an operation of providing a conversation history list that summarizes each conversation information based on the user input, and an operation of providing conversation information selected by a user from the conversation history list.

The method may further include an operation of identifying whether a response of the selected conversation information is associated with a time and a position, an operation of updating the identified response based on a current time and a current position of the electronic device, and an operation of displaying an original response of the identified response together with the updated response.

The method may further include an operation of displaying an original response of the identified response together with the updated response.

The method may further include an operation of receiving, from the user, a selection of a previous user query in conversation history information; and performing a task for the selected user query based on a current time and a current position of the electronic device.

The method may further include an operation of not performing a task for the user query, and searching for a response to the previous user query from the memory when the user query is the same as a previous user query included in conversation history information, and an operation of providing the retrieved response.

The method may further include an operation of generating a summary keyword based on a user query and a response to the user query included in conversation history information, an operation of providing a summary keyword based on a scroll position when a scroll input is detected in the conversation history information, and an operation of providing conversation information corresponding to the summary keyword when the summary keyword is selected.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display;
memory, comprising one or more storage media, storing instructions; and
at least one processor communicatively coupled to the display and the memory,
wherein the instructions, when executed by the at least one processor individually or collectively, cause the electronic device to:
receive a user query via a voice assistant,
identify previous conversation information having a conversation topic associated with the user query,
in case that the identified previous conversation information exists, display a previous conversation retrieval object on the display,
identify whether a user input selecting the previous conversation retrieval object is detected, and
if the user input is detected, provide a response, based on the identified previous conversation information and the user query.

2. The electronic device of claim 1, wherein the instructions, when executed by the at least one processor individually or collectively, further cause the electronic device to:
in case that the identified previous conversation information does not exist, transmit the user query to a server, and
obtain a response to the user query from the server, and provide the response.

3. The electronic device of claim 1, wherein the instructions, when executed by the at least one processor individually or collectively, further cause the electronic device to:
analyze a previous user query and a response corresponding to the previous user query,
based on a result of the analysis, group conversation information corresponding to the same conversation topic,
assign a conversation topic identifier to the grouped conversation information, and
identify a conversation topic identifier associated with the user query, and determine whether the user query is associated with previous conversation information.

4. The electronic device of claim 1, wherein the instructions, when executed by the at least one processor individually or collectively, further cause the electronic device to:
if the user input is detected, provide the previous conversation information, and
in case that a plurality of pieces of previous conversation information exist, provide a list in which each previous conversation information is summarized, and provide previous conversation information selected by a user from the list.

5. The electronic device of claim 1, wherein the instructions, when executed by the at least one processor individually or collectively, further cause the electronic device to:
detect a user input requesting conversation history information,
based on the user input, provide a conversation history list in which each conversation information is summarized, and
provide conversation information selected by a user from the conversation history list.

6. The electronic device of claim 5, wherein the instructions, when executed by the at least one processor individually or collectively, further cause the electronic device to:
identify whether a response in the selected conversation information is associated in terms of time and position, and
based on a current time and a current position of the electronic device, update the identified response.

7. The electronic device of claim 6, wherein the instructions, when executed by the at least one processor individually or collectively, further cause the electronic device to display an original response of the identified response, together with the updated response.

8. The electronic device of claim 1, wherein the instructions, when executed by the at least one processor individually or collectively, further cause the electronic device to:
receive, from the user, a selection of a previous user query in conversation history information, and
based on a current time and a current position of the electronic device, perform a task for the selected user query.

9. The electronic device of claim 1, wherein the instructions, when executed by the at least one processor individually or collectively, further cause the electronic device to:
in case that the user query is the same as a previous user query included in conversation history information, not perform a task for the user query, but search the memory for a response to the previous user query, and
provide the searched response.

10. The electronic device of claim 1, wherein the instructions, when executed by the at least one processor individually or collectively, further cause the electronic device to:
based on a user query and a response to the user query, included in conversation history information, generate summary keywords,
in case that a scroll input is detected in the conversation history information, provide a summary keyword according to a scroll position, and
if the summary keyword is selected, provide conversation information corresponding to the summary keyword.

11. A method of operating an electronic device, the method comprising:
receiving a user query via a voice assistant;
identifying previous conversation information having a conversation topic associated with the user query;
in case that the identified previous conversation information exists, displaying a previous conversation retrieval object on a display of the electronic device;
identifying whether a user input selecting the previous conversation retrieval object is detected; and
if the user input is detected, providing a response, based on the identified previous conversation information and the user query.

12. The method of claim 11, further comprising:
in case that the identified previous conversation information does not exist, transmitting the user query to a server; and
obtaining a response to the user query from the server, and providing the response.

13. The method of claim 11, further comprising:
analyzing a previous user query and a response corresponding to the previous user query;
based on a result of the analysis, grouping conversation information corresponding to the same conversation topic;
assigning a conversation topic identifier to the grouped conversation information; and
identifying a conversation topic identifier associated with the user query, and determining whether the user query is associated with previous conversation information.

14. The method of claim 11, further comprising:
if the user input is detected, providing the previous conversation information; and
in case that a plurality of pieces of previous conversation information exist, providing a list in which each previous conversation information is summarized, and providing previous conversation information selected by a user from the list.

15. The method of claim 11, further comprising:
detecting a user input requesting conversation history information;
based on the user input, providing a conversation history list in which each conversation information is summarized; and
providing conversation information selected by a user from the conversation history list.

16. The method of claim 15, further comprising:
identifying whether a response in the selected conversation information is associated in terms of time and position; and
based on a current time and a current position of the electronic device, updating the identified response.

17. The method of claim 16, further comprising:
displaying an original response of the identified response, together with the updated response.

18. The method of claim 11, further comprising:
receiving, from the user, a selection of a previous user query in conversation history information; and
based on a current time and a current position of the electronic device, performing a task for the selected user query.

19. One or more non-transitory computer-readable storage media storing one or more computer programs including computer-executable instruction that, when executed by one or more processors of an electronic device individually or collectively, cause the electronic device to perform operations, the operations comprising:
receiving a user query via a voice assistant;
identifying previous conversation information having a conversation topic associated with the user query;
in case that the identified previous conversation information exists, displaying a previous conversation retrieval object on a display of the electronic device;
identifying whether a user input selecting the previous conversation retrieval object is detected; and
if the user input is detected, providing a response, based on the identified previous conversation information and the user query.

20. The one or more non-transitory computer-readable storage media of claim 19, the operations further comprising:
in case that the identified previous conversation information does not exist, transmitting the user query to a server; and
obtaining a response to the user query from the server, and providing the response.
